(19) United States
(12) Patent Application Publication
(10) Pub. No.: US 2023/0413132 A1
(43) Pub. Date: Dec. 21, 2023

(54) METHOD AND APPARATUS FOR PERFORMING FAST LINK ADAPTATION BASED ON SOUNDING REFERENCE SIGNAL IN WIRELESS COMMUNICATION SYSTEM

(71) Applicant: Samsung Electronics Co., Ltd., Suwon-si (KR)

(72) Inventors: Deokhui LEE, Suwon-si (KR); Dongmyung KIM, Suwon-si (KR); Juho LEE, Suwon-si (KR)

(21) Appl. No.: 18/335,798

(22) Filed: Jun. 15, 2023

(30) Foreign Application Priority Data
Jun. 17, 2022 (KR) 10-2022-0074335

(51) Int. Cl. H04W 36/00; H04L 5/00

(52) U.S. Cl. CPC H04W 36/0058; H04W 36/00837; H04L 5/0051

(57) ABSTRACT

A method of performing fast link adaptation through sounding reference signal (SRS) overhearing when handover is required as a user equipment (UE) is moved in a wireless communication system. The method includes transmitting, to a UE served by a first BS, configuration information for at least one measurement report (MR), receiving, from the UE, an MR associated with an event detected by the UE based on the configuration information for the at least one MR, and transmitting, to at least one second BS, a first message including overhearing configuration information associated with a SRS transmitted from the UE to the first BS, wherein the overhearing configuration information is used for overhearing the SRS by the at least one second BS.

### CROSS-REFERENCE TO RELATED APPLICATION

This application is based on and claims priority under 35 U.S.C. § 119 to Korean Patent Application No. 10-2022-0074335, filed on Jun. 17, 2022 in the Korean Intellectual Property Office, the disclosure of which is incorporated by reference herein in its entirety.

### BACKGROUND

### 1. Field

The disclosure relates to a wireless communication system, and more particularly, to a method and apparatus for performing fast link adaptation using sounding reference signal (SRS) overhearing.

### 2. Description of the Related Art

Looking back through successive generations at a process of development of radio communication, technologies for human-targeted services such as voice, multimedia, data or the like have been developed. Connected devices that are on the explosive rise after commercialization of fifth-generation (5G) communication systems are expected to be connected to communication networks. As examples of things connected to networks, there may be cars, robots, drones, home appliances, displays, smart sensors installed in various infrastructures, construction machinery, factory equipment, etc. Mobile devices are expected to evolve into various form factors such as augmentation reality (AR) glasses, virtual reality (VR) headsets, hologram devices, and the like. In order to provide various services by connecting hundreds of billions of devices and things in the sixth-generation (6G) era, there are ongoing efforts to develop better 6G communication systems. For these reasons, 6G communication systems are referred to as beyond-systems.

In the 6G communication system expected to become a reality by around 2030, a maximum transfer rate is tera bits per second (bps), i.e., 1000 giga bps, and a maximum wireless delay is 100 micro seconds (pec). In other words, compared to the 5G communication system, the transfer rate becomes 50 times faster and the wireless delay is reduced to a tenth ( 1/10) in the 6G communication system.

To attain these high data transfer rates and ultra-low delay, the 6G communication system is considered to be implemented in the terahertz (THz) band (e.g., ranging from 95 gigahertz (GHz) to 3 THz). Due to the more severe path loss and atmospheric absorption phenomenon in the THz band as compared to the millimeter wave (mmWave) band introduced in systems, importance of technology for securing a signal range, i.e., coverage, is expected to grow. As major technologies for securing coverage, radio frequency (RF) elements, antennas, new waveforms superior to orthogonal frequency division multiplexing (OFDM) in terms of coverage, beamforming and massive multiple-input and multiple-output (massive MIMO), full dimensional MIMO (FFD-MIMO), array antennas, multiple antenna transmission technologies such as large scale antennas, etc., need to be developed. Besides, new technologies for increasing coverage of THz band signals, such as metamaterial based lenses and antennas, a high-dimensional spatial multiplexing technique using orbital angular momentum (OAM), reconfigurable intelligent surface (RIS), etc., are being discussed.

Furthermore, in order to enhance frequency efficiency and system networks, a full duplex technology by which both uplink and downlink transmissions use the same frequency resource at the same time, a network technology that comprehensively uses satellite and high-altitude platform stations (HAPS) and the like, a network structure innovation technology supporting mobile base stations and allowing optimization and automation of network operation, a dynamic spectrum sharing technology through collision avoidance based on spectrum usage prediction, an artificial intelligence (AI) based communication technology to realize system optimization by using AI from the designing stage and internalizing an end-to-end AI supporting function, a next generation distributed computing technology to realize services having complexity beyond the limit of terminal computing capability by using ultrahigh performance communication and computing resources (e.g., mobile edge computing (MEC) cloud) are being developed in the 6G communication system. In addition, by designing new protocols to be used in 6G communication systems, developing mechanisms for implementing a hardware-based security environment and safe use of data, and developing technologies for protecting privacy, attempts to strengthen connectivity between devices, further optimize the network, promote softwarization of network entities, and increase the openness of wireless communication are continuing.

With such research and development of the 6G communication system, it is expected that new levels of the next hyper-connected experience become possible through hyper-connectivity of the 6G communication system including not only connections between things but also connections between humans and things. Specifically, it is predicted that services such as truly immersive extended reality (truly immersive XR), high-fidelity mobile hologram, digital replication, etc., may be provided. Furthermore, services such as remote surgery, industrial automation and emergency response with enhanced security and reliability may be provided through the 6G communication system to be applied in various areas such as industry, medical care, vehicles, appliances, etc.

### SUMMARY

Embodiments of the disclosure provide a method and apparatus for performing fast link adaptation through sounding reference signal (SRS) overhearing when handover is required with movement of a user equipment (UE) in a wireless communication system.

Additional aspects will be set forth in part in the description which follows and, in part, will be apparent from the description, or may be learned by practice of the presented embodiments of the disclosure.

According to an embodiment of the disclosure, provided is a method of performing communication by a first base station (BS) in a wireless communication system. The method includes transmitting, to a user equipment (UE) served by the first BS, configuration information for at least one measurement report (MR), receiving, from the UE, an MR associated with an event detected by the UE based on the configuration information for the at least one MR, and transmitting, to at least one second BS, a first message including overhearing configuration information associated with a sounding reference signal (SRS) transmitted from the UE to the first BS, wherein the overhearing configuration information is used for overhearing the SRS by the at least one second BS.

According to an embodiment of the disclosure, the overhearing configuration information may include at least one of an antenna port information or a time-frequency resource information in which an SRS for which overhearing is requested is transmitted, and the at least one second BS having received the first message including overhearing configuration information may receive the SRS based on at least one of the time-frequency resource information or the antenna port information.

According to an embodiment of the disclosure, the configuration information for MR may include configuration information relating to a criterion of triggering an event related to handover, and the transmitting of the first message including the overhearing configuration information may include transmitting a handover request message including the overhearing configuration information to the at least one second BS when an MR corresponding to the event related to handover is received.

According to an embodiment of the disclosure, the configuration information for MR may include at least one of configuration information relating to a criterion of triggering an event related to overhearing or configuration information relating to a criterion of triggering an event related to handover, and the transmitting of the first message including the overhearing configuration information may include transmitting the first message including the overhearing configuration information to the at least one second BS when at least one of an MR corresponding to an event related to overhearing or an MR corresponding to an event related to handover is received.

According to an embodiment of the disclosure, the method may further include receiving a response to the overhearing configuration information from the at least one second BS, and transmitting a handover request message for the UE to the at least one second BS.

According to an embodiment of the disclosure, the configuration information for MR may include configuration information relating to a criterion of triggering a multiple transmission-reception-point (TRP) configuration event, and the method may further include transmitting configuration information for multiple TRPs to the UE when an MR corresponding to the multiple-TRP configuration event is received from the UE, and transmitting, to the at least one second B S, a fast link adaptation request message including information of a UE in which the multiple-TRP configuration event occurs, and, based on the fast link adaptation request message, an SRS is transmitted from the UE to the at least one second BS when a control signal to request SRS transmission may be transmitted from the at least one second BS to the UE.

According to an embodiment of the disclosure, provided is a method of performing communication by a second BS in a wireless communication system. The method includes, receiving, from a first BS, a first message including overhearing configuration information associated with an SRS transmitted to the first BS from the UE, transmitting, to the first BS, a response message in response to receiving the first message, receiving the SRS based on the overhearing configuration information.

According to an embodiment of the disclosure, provided is a method performing communication by a UE in a wireless communication system. The method includes receiving configuration information for at least one MR from a first BS which is a serving BS, and when detecting an event based on the configuration information for the at least one MR, transmitting, to the first BS, an MR associated with the event, wherein a first message including overhearing configuration information is received by at least one second BS for handover from the first BS based on the received MR, the at least one second BS receives an SRS transmitted from the UE to the first BS, based on the overhearing configuration information.

According to an embodiment of the disclosure, provided is a first BS for performing communication in a wireless communication system. The first BS includes a transceiver, and at least one processor coupled to the transceiver, wherein the at least one processor is configured to transmit, to a UE served by the first BS, configuration information for at least one MR, receive, from the UE, an MR corresponding to an event when the event is detected by the UE based on the configuration information for the at least one MR, and transmit, to at least one second BS for handover, overhearing configuration information for a SRS transmitted from the UE to the first BS, wherein the overhearing configuration information is used to estimate a channel state based on the SRS between the at least one second BS and the UE.

According to an embodiment of the disclosure, provided is a second BS for performing communication in a wireless communication system. The second BS includes a transceiver, and at least one processor coupled to the transceiver, wherein the at least one processor is configured to, in response to a first BS receiving an MR corresponding to an event from a UE served by the first BS based on the event detected by the UE based on configuration information for at least one MR, receive overhearing configuration information for a SRS transmitted to the first BS from the UE based on the received MR, receive the SRS based on the overhearing configuration information, and estimate a channel state between the UE and the second BS based on the received SRS.

According to an embodiment of the disclosure, a UE for performing communication in a wireless communication system includes a transceiver, and at least one processor coupled to the transceiver, wherein the at least one processor is configured to receive configuration information for at least one MR from a first BS which is a serving BS, and transmit, to the first BS, an MR corresponding to an event when the event is detected by the UE based on the configuration information for the at least one MR, overhearing configuration information is received by at least one second BS for handover from the first BS based on the received MR, the at least one second BS receives an SRS transmitted from the UE to the first BS, based on the overhearing configuration information, and a channel state between the UE and the at least one second BS is estimated based on the SRS.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of time-frequency domain, which is a radio resource domain;

FIG. 2 illustrates a structure of a UL in which a sounding reference signal (SRS) is transmitted;

FIG. 3 illustrates a diagram for describing how to perform fast link adaptation, according to an embodiment of the disclosure;

FIG. 4 illustrates a flow chart for describing fast link adaptation based on an SRS during handover, according to an embodiment of the disclosure;

FIG. 5 illustrates a flow chart illustrating application of SRS-based fast link adaptation to random access channel less (RACH-less) handover, according to an embodiment of the disclosure;

FIG. 6 illustrates a flow chart illustrating application of SRS-based fast link adaptation to conditional handover, according to an embodiment of the disclosure;

FIG. 7 illustrates a flow chart for describing transmission of an extra message for SRS overhearing in SRS-based fast link adaptation, according to an embodiment of the disclosure;

FIG. 8 illustrates a flow chart for describing presence of multiple events in SRS-based fast link adaptation, according to an embodiment of the disclosure;

FIG. 9 illustrates a flow chart for describing additional transmission of an SRS configuration message in SRS-based fast link adaptation, according to an embodiment of the disclosure;

FIG. 10 illustrates a diagram for describing multiple transmission-reception points (TRPs) to which SRS-based overhearing is applied, according to an embodiment of the disclosure;

FIG. 11 illustrates a diagram illustrating application of an SRS-based fast link adaptation method to a base station (BS) configured with multiple TRPs, according to an embodiment of the disclosure;

FIGS. 12A and 12B illustrate diagrams for describing change trends of transfer rate in a case of performing an SRS-based fast link adaptation method, according to an embodiment of the disclosure;

FIG. 13 illustrates a schematic block diagram illustrating a configuration of a user equipment (UE), according to an embodiment of the disclosure; and

FIG. 14 illustrates a schematic block diagram illustrating a configuration of a BS, according to an embodiment of the disclosure.

### DETAILED DESCRIPTION

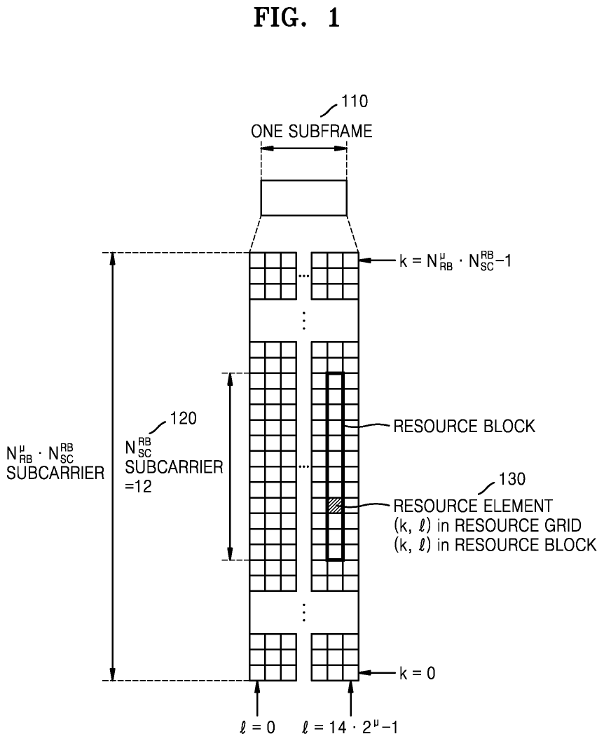

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the disclosure will now be described in detail with reference to accompanying drawings.

Various modifications may be made to embodiments of the disclosure, which will be described more fully hereinafter with reference to the accompanying drawings. The disclosure should be understood as not limited to particular embodiments but including all the modifications, equivalents and replacements which belong to technical scope and ideas of the disclosure.

Some related well-known technologies that possibly obscure the disclosure will not be described. Ordinal numbers (e.g., first, second, etc.) as herein used are to distinguish components from one another.

The terms are selected from among common terms widely used at present, taking into account principles of the disclosure, which may however depend on intentions of those of ordinary skill in the art, judicial precedents, emergence of new technologies, and the like. Some terms as herein used are selected at the applicant's discretion, in which case, the terms will be explained later in detail in connection with embodiments of the disclosure. Therefore, the terms should be defined based on their meanings and descriptions throughout the disclosure.

The scope of the disclosure is defined by the appended claims rather than the detailed descriptions. Various features recited in a claim category, e.g., a method claim, of the disclosure may also be claimed in another claim category, e.g., a system claim. Embodiments of the disclosure may include not only a combination of features specified in the appended claims but also various combinations of individual features in the claims. It will be understood by those of ordinary skill in the art that various changes in form and details may be made without departing from the spirit and scope of the disclosure as defined by the appended claims and their equivalents.

When the term “connected” or “coupled” is used, a component may be directly connected or coupled to another component. However, unless otherwise defined, it is also understood that the component may be indirectly connected or coupled to the other component via another new component. It also includes not only an occasion of being “directly connected” or “physically connected”, but also an occasion of being “electrically connected” with another component in between. In the disclosure, the terms “transmit”, “receive” and “communicate” imply both direct and indirect communication.

The term “include (or including)” or “comprise (or comprising)” is inclusive or open-ended and does not exclude additional, unrecited elements or method steps.

Throughout the specification, a component expressed with “ . . . unit”, “ . . . module”, or the like may be a combination of two or more components or may be divided by function into two or more. The function may be implemented in hardware, software, or a combination thereof. Each of the components may perform its major function and further perform part or all of a function served by another component. In this way, part of a major function served by each component may be dedicated and performed by another component.

As used herein, the singular forms “a”, “an” and “the” are intended to include the plural forms as well, unless the context clearly indicates otherwise. All terms including technical and scientific terms used herein have the same meaning as commonly understood by one of ordinary skill in the art to which this disclosure belongs.

Throughout the specification, the expression “or” is inclusive rather than exclusive, unless specifically mentioned otherwise. Hence, unless the context clearly indicates otherwise, “A or B” may refer to “A”, “B” or both. Throughout the disclosure, the expression “at least one of” or “one or more” may indicate different combinations of one or more of items enumerated or may refer to an occasion when an arbitrary one of the items enumerated is required. For example, “at least one of A, B, and C” may include any of the following combinations: A, B, C, A and B, A and C, B and C, or A, B and C.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

It will be understood that each block and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-usable or computer-readable memories oriented for computers or other programmable data processing equipment, so it is possible to manufacture a product that contains instruction means for performing functions described in the block(s) of the flowchart. The computer program instructions may also be loaded on computers or programmable data processing equipment, so it is possible for the instructions to generate a process executed by the computer or the other programmable data processing equipment to provide steps for performing functions described in the block(s) of the flowchart.

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order.

Embodiments of the disclosure will now be described with reference to accompanying drawings to assist those of ordinary skill in the art in readily implementing them. However, the embodiments of the disclosure may be implemented in many different forms, and not limited thereto as will be discussed herein. In the drawings, parts unrelated to the description are omitted for clarity, and like numerals refer to like elements throughout the specification.

Although the following embodiments of the disclosure will be focused on the long term evolution (LTE), LTE-Advanced (LTE-A) or a fifth generation (5G) system as an example, they may be applied to other communication systems with similar technical backgrounds or channel types. For example, the other communication systems may include a 5G-Advanced or sixth generation (6G) (beyond 5G) communication technology developed after the 5G mobile communication technology (NR), and the term 5G may be a concept including the existing LTE, LTE-A and other similar services. Furthermore, embodiments of the disclosure will also be applied to different communication systems with some modifications to such an extent that does not significantly deviate from the scope of the disclosure when judged by those of ordinary skill in the art.

Terms as used herein will be described before detailed description of embodiments of the disclosure.

The terms, as will be mentioned later, are defined by taking functionalities in the disclosure into account, but may vary depending on practices or intentions of users or operators. Accordingly, the terms should be defined based on descriptions throughout this specification.

A base station (BS) as herein used may refer to an entity for performing resource allocation for a user equipment (UE) and may be at least one of gNode B, eNode B, Node B (or, x Node B, where x represents any letter including ‘g’ and ‘e’), a radio access unit, a BS controller, a satellite, an airborne vehicle or a node in a network, without being limited thereto. In the disclosure, the BS may refer to the BS itself, a cell or a radio unit (RU) depending on the interpretation, and an entity that exchanges messages with the UE may be a distributed unit (DU) or a central unit (CU) depending on the structure.

Furthermore, the UE as herein used may include a mobile station (MS), a cellular phone, a smart phone, a computer, a vehicle, a satellite, or a multimedia system capable of performing a communication function.

In the disclosure, the term ‘uplink (UL)’ refers to a radio transmission link for a signal transmitted by the UE to the BS.

Furthermore, in the disclosure, a transmission-reception point (TRP) may have the same physical cell identity (PCI) or different PCIs, and may refer to an RU or a cell.

Reference signal received power (RSRP) as herein used refers to strength of a signal spreading across the entire bandwidth and a narrow band.

Reference signal received quality (RSRQ) in the disclosure refers to quality that takes the number N of resource blocks used for measurement based on received signal strength indicator (RSSI) and the same bandwidth, which may be obtained by (N*RSRP)/RSSI.

In the following description, the terms referring to broadcast information, control information, state changes (e.g., events), network entities, messages, and components of an apparatus, the terms related to communication coverage, etc., are mentioned for convenience of explanation. The disclosure is not limited to the terms as will be used in the following description, and may use different terms having the same meaning in a technological sense.

In the following description, for convenience of explanation, terms and definitions used in the most recent standards among the currently existing communication standards, i.e., in the LTE and NR standard defined in the 3rd Generation Partnership Project (3GPP) will be used in the disclosure. The disclosure is not, however, limited to the terms and definitions, and may be equally applied to any systems that conform to other standards.

With the development of mobile communication technologies, various types of UE appear and the number of devices owned by each person is on the rise. Furthermore, as for 5G technologies, beamforming is used to provide wireless communication, leading to an increase in density of BSs as compared to the previous technologies due to the limit of straightness of signals. Wireless communication systems that may be provided after 5G have higher chances of having such features. Highly mobile UEs may include, for example, a device attached to a vehicle or a mobile object, a wearable device worn and carried by the user, etc. The wearable device may include at least one of accessory typed devices (e.g., watches, rings, wrist bands, ankle bands, necklaces, glasses, contact lenses), Head-Mounted Devices (HMDs), cloth or clothing typed devices (e.g., electronic clothing), body-attachable devices (e.g., skin pads), and implantable devices (e.g., implantable circuits), without being limited thereto.

With the increase in UE mobility and BS density, handover may occur frequently. Handover may lead to changing BS to serve the UE, and cause deterioration of communication performance for a time taken for configuration of information used for communication between the changed BS and the UE. For example, significant throughput degradation may occur right after handover. Reasons for the throughput degradation may include handover interruption time and robust (or conservative) allocation of a number of modulation and coding scheme (MCS) levels and layers or the like. How to solve the throughput degradation due to the handover interruption time has thus far been mainly discussed. The disclosure proposes a method of solving the throughput degradation caused by e.g., robust allocation of a number of MCS levels and layers during handover.

FIG. 1 illustrates a basic structure of time-frequency domain, which is a radio resource domain.

Referring to FIG. 1, the horizontal axis of a graph represents a time domain, and the vertical axis represents a frequency domain. A minimum transmission unit of the time domain is an orthogonal frequency division multiplexing (OFDM) symbol for downlink (DL) and an OFDM symbol or a discrete Fourier transform-spread-orthogonal frequency division multiplexing (DFT-s-OFDM) symbol for UL.

When a normal cyclic prefix (NCP) is used in the OFDM symbol or the DFT-s-OFDM symbol, 14 symbols constitute one slot. One subframe is defined to be 1 ms. Table 1 represents the number of slots of each of a frame and a subframe depending on numerology.

TABLE 1
NUMBER OF SLOTS OF FRAME AND SUBFRAME OF OFDM
OR DFT-S-OFDM ACCORDING TO NUMEROLOGY

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In Table 1, N_{symb}^{slot} denotes the number of symbols included in one slot, which is constantly 14 regardless of the value of μ (numerology). Nₛₗₒₜ^{frame,μ} denotes the number of slots included in one frame depending on the value of μ, and Nₛₗₒₜ^{subframe,μ} refers to the number of slots included in one subframe depending on the value of μ. As the value of μ increases, the number of slots that make up the frame and the subframe increases. For example, when the value of μ is 1, the number of OFDM symbols per slot is 14, and one frame has 20 slots and one subframe has two slots.

A minimum transmission unit in the frequency domain is a subcarrier, and the whole system transmission bandwidth is comprised of a total of N_{RB}^{μ}·N_{SC}^{RB} subcarriers. N_{RB}^{μ} refers to the number of resource blocks depending on the value of μ, ands N_{SC}^{RB} is a resource block 120, which may be comprised of 12 successive subcarriers in the frequency domain. The basic resource unit in the time-frequency domain is a resource element (RE) 130, which may be defined with an OFDM/DFT-s-OFDM symbol index and a subcarrier index. Table 2 represents a value of N_{RB,x}^{max,μ} or N_{RB,x}^{min,μ} corresponding to a maximum value or a minimum value of the number of resource blocks depending on the value of μ in UL or DL.

TABLE 2
NUMBER OF RESOURCE BLOCKS
ACCORDING TO NUMEROLOGY

| μ | N_{RB, DL}^{min, μ} | N_{RB, DL}^{max, μ} | N_{RB, UL}^{min, μ} | N_{RB, UL}^{max, μ} |
|---|---|---|---|---|
| 0 | 20 | 275 | 24 | 275 |
| 1 | 20 | 275 | 24 | 275 |
| 2 | 20 | 275 | 24 | 275 |
| 3 | 20 | 275 | 24 | 275 |
| 4 | 20 | 138 | 24 | 138 |
| 5 | 20 | 69 | 24 | 69 |

Wireless communication systems employ a multi-antenna scheme as one of the technologies for UL performance enhancement. With a single user (SU) multiple-input multiple-output (MIMO) (SU-MIMO) scheme, which is a classic example of the multi-antenna scheme, the BS may use up to 4 transmit antennas in a UL to enhance UL performance. For the SU-MIMO scheme, the BS may estimate a channel state of the whole UL transmission band for each UE's transmit antenna and determine a precoding matrix to be used by the respective UEs. The BS may obtain UL channel information for each UE by receiving a sounding reference signal (SRS) transmitted from the UE. The BS performs the determination of the precoding matrix based on the obtained UL channel information for each UE, UL frequency-selective scheduling, power control, and MCS level selection.

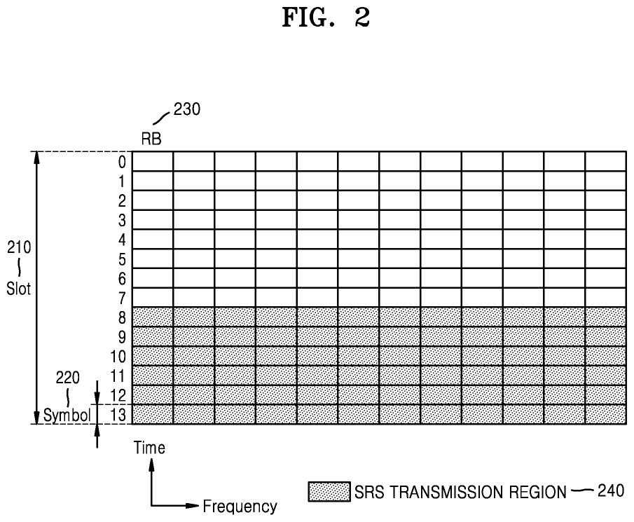

FIG. 2 illustrates a structure of a UL in which an SRS is transmitted.

Referring to FIG. 2, a slot 210 may be defined as a basic unit for scheduling signal transmission or reception. Assuming a normal cyclic prefix (CP) length, each slot has 14 symbols 220, and each symbol may correspond to a UL waveform symbol. For UL waveform, CP-OFDM or DFT-S-OFDM may be used as an example, and embodiments of the disclosure may be equally applied to symbols corresponding to other UL waveforms.

A resource block (RB) 230 is a resource allocation unit in the frequency domain, and has 12 subcarriers.

The UL structure may be largely divided into control area and data area. In the UL structure, the control area includes time-frequency resources in which a DL channel quality report, acknowledgment (ACK)/non-acknowledgment (NACK) of DL signal reception, a UL scheduling request, or the like is transmitted from each UE. The data area of the UL structure includes time-frequency resources in which data such as voice or a packet is transmitted, and corresponds to other resources than the control area among the whole time-frequency resources.

In the UL structure, a reference signal (RS) may be transmitted in the data area. The RS transmitted by the UE may include an SRS. The SRS may be used to measure a condition of a UL channel.

The UE may receive, from the BS, configuration information for time-frequency resource to transmit an SRS. The configuration information may be received by higher layer signaling (e.g., radio resource control (RRC) signaling or a medium access control (MAC) control element (CE). However, this is merely an embodiment of the disclosure, and the time-frequency resource to transmit an SRS may be configured by a combination of two or more of a L1 signal and higher layer signals (e.g., RRC signals or MAC CEs).

A section that allows transmission of the SRS may be limited to a particular symbol region in one slot. For example, symbols in which the UE is able to transmit the SRS periodically in one slot may be in a region of last 6 symbols 240. The number N of symbols for the SRS may be set to 1, 2 or 4, and the SRS may be transmitted in successive symbols. In the frequency domain, resources may be configured in a unit of a multiple of 4 RBs for SRS transmission, and up to 272 RBs may be configured in the frequency domain. However, this is merely an example, and the SRS may be transmitted in other time resources or frequency resources.

Furthermore, an SRS transmission method may be configured by a control signal from the BS. In the disclosure, the control signal may be higher layer signaling including RRC signaling or MAC CE signaling, L1 signaling (e.g., DL control indicator (DCI)) or a combination of two or more of them. Furthermore, in the disclosure, information configured by the BS for the UE may be transmitted in the aforementioned control signal. The SRS may be configured to be repetitively transmitted. For example, when one SRS antenna port is mapped to one symbol for transmission, up to 4 symbols may be repetitively transmitted. Unlike this, 4 different antenna ports may be mapped to 4 different symbols. This is a case in which each antenna port is mapped to one symbol, so repetitive transmission of the SRS symbol is not allowed.

The SRS is composed of a constant amplitude zero auto correlation (CAZAC) sequence. CAZAC sequences that make up the respective SRSs transmitted from multiple UEs have different cyclic shift values. Each of the CAZAC sequences generated by cyclic shift from one CAZAC sequence is characterized to have a zero correlation value with other sequences having different cyclic shift values. SRSs simultaneously allocated to the same frequency domain by using the above characteristics may be distinguished by a CAZAC sequence cyclic shift value set for each SRS.

SRSs of multiple UEs may be distinguished not only by the cyclic shift values but also frequency locations. The frequency locations are distinguished by allocation of an SRS subband unit or Comb. The type of Comb may be determined according to spacing of subcarriers to which the SRS is allocated in the SRS subband. For example, for Comb2, one SRS is allocated to an even-numbered or odd-numbered subcarrier in the SRS subband, and even-numbered subcarriers and odd-numbered subcarriers each make up one comb.

UL channel information estimated based on the SRS may be used for beam management, antenna switching, etc., in the BS. When multiple antennas are used, the UE transmits the SRS in multi-directional beams. On receiving the SRS from the UE, the BS may obtain information used for the UL channel. For example, using the SRS transmitted in the multi-directional beams, a channel state in each direction may be figured out, and information about which direction of beam is to be used and a rank value may be obtained. Based on the information used for the UL channel, the UE performs UL transmission.

Meanwhile, in embodiments of the disclosure, a BS, which is not a serving cell, may perform fast link adaptation by using the SRS transmitted by the UE. The operation of the BS, which is not a serving cell for the UE, receiving the SRS of the UE will now be described as overhearing.

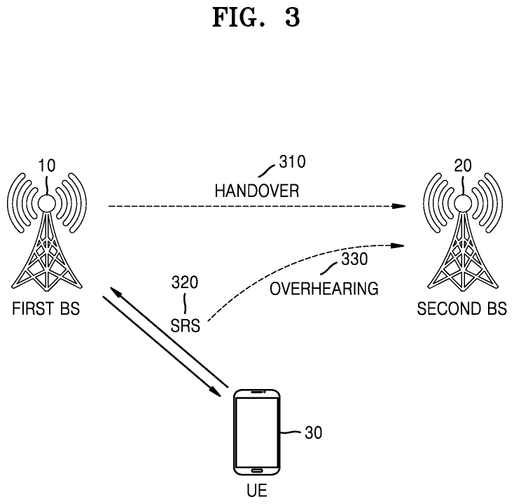

FIG. 3 illustrates a sequence chart for describing a method of performing fast link adaptation based on an SRS during handover, according to an embodiment of the disclosure.

Referring to FIG. 3, a wireless communication system that performs the fast link adaptation method according to an embodiment of the disclosure may include a first BS 10, at least one second BS 20 and a UE 30. The first BS 10 may be a serving BS of the UE 30.

The first BS 10 may configure one or more events for measurement report (MR) for the UE 30 to determine whether to configure overhearing based on the SRS. The UE 30 may identify that the event occurs when a measurement of a signal transmitted from the first BS 10 or the second BS 20 to the UE 30 meets a preset reference. The reference may be differently set for each event, and the first BS 10 may provide information about the reference for each event to the UE 30 through MR configuration information. When the event occurs, the UE 30 may transmit an MR to the first BS 10. In an embodiment of the disclosure, to trigger an MR for overhearing, an event defined for handover, an event defined for configuration of multiple transmission-reception points (TRPs), etc., may be used. In an embodiment of the disclosure, a new event may be defined to trigger an MR for overhearing.

The UE 30 may transmit an MR to the first BS 10 when detecting an event for MR configured by the first BS 10. On receiving the MR from the UE 30, the first BS 10 may transmit overhearing configuration information to the second BS 20. The overhearing configuration information may be transmitted in a handover request message or a message defined separately for overhearing (e.g., an overhearing request message).

The overhearing configuration information may include SRS configuration information configured by the first BS 10 for the UE 30. The SRS configuration information may include the aforementioned SRS time-frequency resource information and information about an SRS type. The SRS time-frequency resource information may be different depending on numerology settings as described above in connection with FIG. 1, and the SRS time-frequency resource information may be transmitted along with information about the numerology. The SRS type may be set to one of ‘periodic’, ‘semi-persistent’, and ‘aperiodic’. The first BS 10 may use a control signal to provide the SRS configuration information to the UE 30.

The first BS 10 may activate or deactivate, or trigger SRS transmission to the UE through higher layer signaling including RRC signaling or MAC CE signaling, or L1 signaling (e.g., DCI). For example, the first BS 10 may activate or deactivate periodic SRS transmission to the UE 30 through higher layer signaling. Furthermore, the first BS 10 may adjust the length of the SRS period through the higher layer signaling.

The second BS 20 may perform overhearing for the SRS transmitted to the first BS 10 from the UE 30 based on the overhearing configuration information received from the first BS 10. For example, the second BS 20 may use the SRS configuration information included in the overhearing configuration information to identify a time-frequency resource in which the SRS is transmitted by the UE 30. The second BS 20 may receive a signal in the identified time-frequency resource, and measure a channel state between the UE 30 and the second BS 20 based on the received signal. The second BS 20 may perform faster link adaptation for communication between the UE 30 and the second BS 20 by measuring the channel state with the UE 30 in advance, in case that the UE 30 performs handover from the first BS 10 to the second BS 20.

In the disclosure, unlike traditional robust allocation of a number of MCS levels and layers because there is no information about a channel between the UE and the BS right after handover, the second BS 20 may allocate the number of MCS levels and layers suitable for the channel state based on information about the channel state between the second BS 20 and the UE 30 obtained in advance by using SRS overhearing. The second BS 20 may quickly restore the transfer rate after handover by allocating the number of MCS levels and layers suitable for the channel state of the UE 30.

In an embodiment of the disclosure, the UE 30 is a mobile terminal, including a cellular phone, a smart phone, a computer, a vehicle, a satellite, or a multimedia system capable of performing a communication function. The UE 30 may include a wearable device, which may include at least one of accessory typed devices (e.g., watches, rings, wrist bands, ankle bands, necklaces, glasses, contact lenses), Head-Mounted Devices (HMDs), cloth or clothing typed devices (e.g., electronic clothing), body-attachable devices (e.g., skin pads), and implantable devices (e.g., implantable circuits), without being limited thereto.

In an embodiment of the disclosure, the first BS 10 or the second BS 20 may refer to a cell or a radio unit (RU). Furthermore, depending on the network structure, the first BS 10 or the second BS 20 may refer to a distributed unit (DU) or a central unit (CU).

Although one second BS 20 is shown in FIG. 3, it is merely an example and the SRS-based overhearing according to the disclosure may also be applied to an occasion when there are multiple second BSs. For example, in a case of conditional handover, a plurality of second BSs may be set as candidates for a target BS, in which case the plurality of second BSs may each be configured to perform SRS-based overhearing.

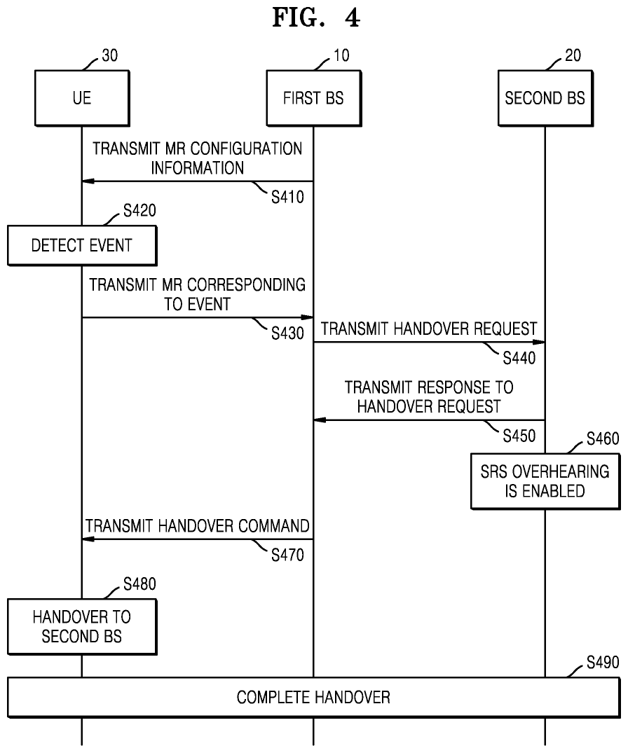

Furthermore, the SRS-based overhearing according to the disclosure may also be applied for legacy handover, radio access channel (RACH)-less handover, conditional handover, dual active protocol handover, etc., without being limited thereto. An embodiment of a specific handover operation will be described in detail in connection with FIGS. 4 to 6.

FIG. 4 illustrates a flow chart for describing a method of performing fast link adaptation based on an SRS during handover, according to an embodiment of the disclosure.

In operation S410, the first BS 10 may transmit information about configuration of at least one MR to the UE 30. The information about configuration of at least one MR will now be referred to as MR configuration information for convenience of explanation.

The MR may be transmitted from the UE 30 to the first BS 10 when a measurement of a signal transmitted from the first BS 10 or the second BS 20 satisfies a preset condition. The preset condition may be different for each event defined by the first BS 10, and information about an MR transmission condition for each event may be included in the MR configuration information. In the disclosure, when the preset condition for each event is satisfied, it is described as an event to trigger an MR being detected.

The UE 30 may compare the measurement of the signal received from the first BS 10 or the second BS 20 with an offset or a threshold set for an Ax event, and perform MR transmission based on the result of the comparing. X is an index used to distinguish the event, and may be set differently for each event. For example, an A3 event may occur when the measurement of a signal received by the UE 30 from an adjacent BS is larger than a measurement of a signal received from a PCell or PSCell by a set offset.

MR configuration information for the A3 event may be provided as in Table 3 below. The MR configuration information for the A3 event may include a3-Offset that represents an offset value, a hysteresis parameter of the A3 event, a triggered time, and measurements for the first BS 10 and the second BS 20.

TABLE 3
MR CONFIGURATION INFORMATION ABOUT EVENT A3

```
ReportConfig information element
  eventA3 SEQUENCE {
            a3-Offset
      MeasTriggerQuantityOffset,
                  .  BOOLEAN,
                  .
                  .
              hysteresis Hysteresis,
              timeToTrigger TimeToTrigger,
              useAllowedCellList BOOLEAN
```

In the disclosure, an event for SRS overhearing may be configured, and the event for SRS overhearing may be described as an Ax event. The event to trigger an MR for SRS overhearing may include an event to trigger an MR for handover, which is defined traditionally, an event to trigger an MR for multiple TRP configuration, etc., which will be described in detail later.

TABLE 4
MR CONFIGURATION
INFORMATION FOR
TWO OR MORE EVENTS

measIdToAddModiList
measId 1,
measObjectId 1,
reportConfigId 1
,
measId 2,
measObjectId 1,
reportConfigId 2

In an embodiment of the disclosure, the MR configuration information may be provided for two or more events. For example, when the BS configures two or more events for the UE 30, it may configure a different offset in a method of assigning different reportConfigId including a value to trigger an MR for each measObjectId, which is information indicating a measurement target in the MR configuration information. For example, reportconfigID1 is configured for an Ax event to trigger an MR for handover and reportconfigID2 is configured for an Ax event to trigger an MR for SRS overhearing, thereby making a difference to the offset values. The MR configuration information may include an event related to handover and an event related to SRS overhearing. An offset of the event related to handover may be set to a value larger than an offset of the event related to SRS overhearing. In operation S420, the UE 30 may detect an event corresponding to the MR configuration information. The UE 30 may detect the event when the measurement of a signal received from the first BS 10 meets a condition for an event configured based on the MR configuration information. For example, the UE 30 may detect at least one of the event related to handover, the event related to SRS overhearing, or the event related to multiple TRP configuration.

In operation S430, the UE 30 may transmit an MR corresponding to the event to the first BS 10.

In an embodiment of the disclosure, the MR corresponding to the event may include information about signal strength and quality of the first BS 10 and the second BS 20. For example, the information about signal strength and quality may include reference signals received power (RSRP), reference signal received quality (RSRQ), and signal to interference and noise ratio (SINR). The MR may also include information about a physical cell identity (PCI) corresponding to the signal strength and quality.

In an embodiment of the disclosure, when there are one or more cells in the PCI transmitted in the MR information, the first BS 10 may request a cell ID for handover from the UE 30. The UE 30 may determine a cell ID corresponding to the request of the first BS 10 and transmit information about the cell ID to the first BS 10. For example, when the cell ID received in response to the request of the first BS 10 is a cell ID of the second BS 20, the first BS 10 may transmit a handover request to the second BS 20 based on the received cell ID.

In operation S440, the first BS 10 may transmit the handover request to the second BS 20. On receiving the MR corresponding to the detected event, the first BS 10 may transmit the handover request to a target for handover, which is the second BS 20.

In an embodiment of the disclosure, the handover request may include a transparent RRC container including a handover preparation information RRC message along with an ID of the second BS 20 and other information.

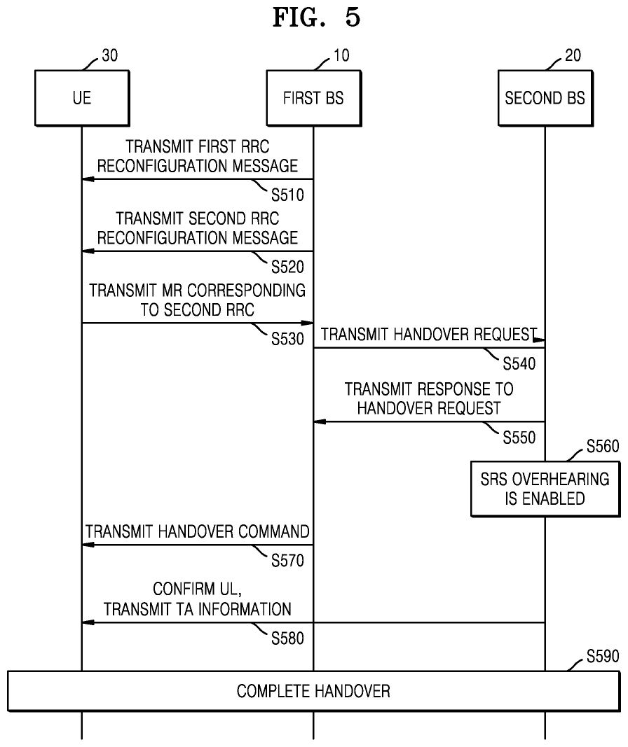

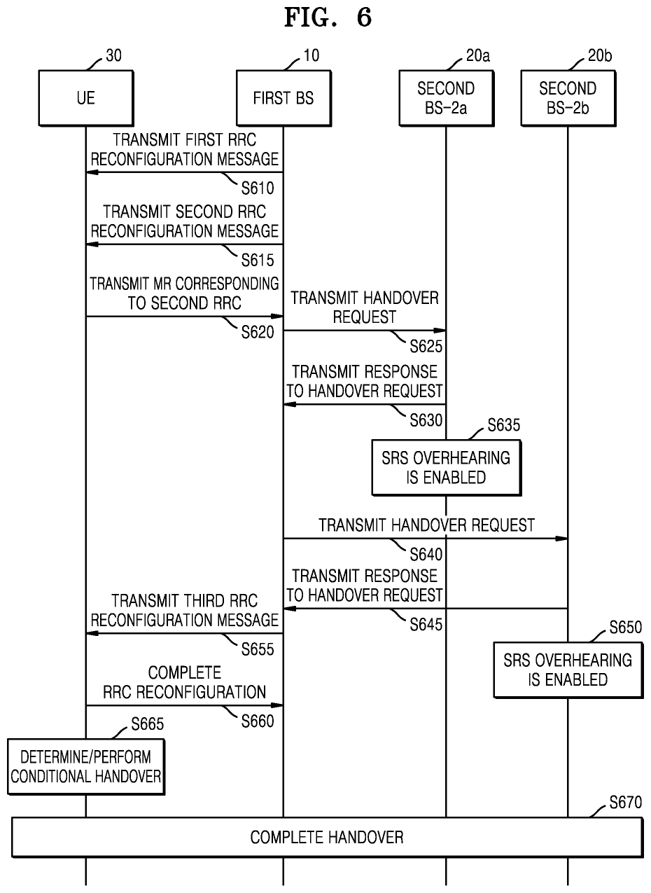

In an embodiment of the disclosure, the handover request may include resource information for handover. The resource information for handover may include other information depending on the type of handover. Embodiments of the RACH-less handover and conditional handover will be described in detail in connection with FIGS. 5 and 6.

In an embodiment of the disclosure, the handover request may include a request for SRS overhearing. The request for SRS overhearing may include information indicating activation of SRS overhearing and information for configuring SRS overhearing. In an embodiment of the disclosure, the overhearing request may be included in the transparent RRC container accompanied by the handover request, or vendor-specifically delivered. For example, the request for SRS overhearing may be configured by “RRC: srs-Config setup” information element (IE) in the RRC message. It is, however, merely an example, and a specific embodiment of the SRS overhearing request will be described later in connection with FIG. 5.

In operation S450, the second BS 20 may transmit a response to the handover request to the first BS 10. The second BS 20 may receive the handover request and transmit ACK or NACK for the handover request.

In an embodiment of the disclosure, the response to the handover request may include a response to the SRS overhearing request. When SRS resource information for overhearing and resource information scheduled for the UE served by the second BS 20 conflicts with each other or when the second BS 20 has no room for PHY processing capability, the second BS 20 may transmit NACK for the SRS overhearing request.

The second BS 20 may transmit a response to the overhearing request for each SRS resource ID. In an embodiment of the disclosure, the response to the overhearing request may be represented by using a bitmap corresponding to the SRS resource ID. The second BS 20 may not respond for a resource for which the SRS overhearing request is not received. In an embodiment of the disclosure, when NACK is to be transmitted for each SRS resource ID, the second BS 20 may transmit the NACK by adding information about a resource that allows SRS overhearing to the NACK. When the first BS 20 is able to configure the UE with a resource that allows SRS overhearing by the second BS 20, the first BS 10 may transmit, to the UE, an RRC message requesting a change in SRS configuration. After transmitting the RRC message, the first BS 10 may transmit, to the second BS 20, an overhearing request based on the changed SRS configuration.

In operation S460, the second BS 20 may perform overhearing on an SRS transmitted by the UE 30 to the first BS 10. The second BS 20 may measure a signal received in the SRS resource identified based on the overhearing configuration information. Furthermore, the overhearing configuration information may include e.g., information about a cyclic shift value used for SRS generation, and based on this, the second BS 20 may identify the SRS. It is, however, merely an example, and the overhearing configuration information may include one or more pieces of information included in the SRS configuration information as described above in connection with FIG. 2. The second BS 20 may estimate a channel between the second BS 20 and the UE 30 through signal measurement. For example, the second BS 20 may estimate a UL channel by measuring SINR, RSSI, and an extent of path loss of the received signal. In addition, the second BS 20 may estimate a DL channel based on the UL channel estimated through the SRS overhearing.

In an embodiment of the disclosure, in case that the distance between the first BS 10 and the second BS 20 is smaller than a certain distance, the second BS 20 may constantly perform the SRS overhearing operation for the UE 30 without being requested by the first BS 10. For example, the second BS 20 may perform the SRS overhearing operation at certain intervals without being requested by the first BS 10.

The second BS 20 may determine the number of MCS levels and layers suitable for the channel state of the UE before start or completion of a handover procedure with the UE 30, based on the estimated UL channel information. Furthermore, the second BS 20 may minimize performance degradation from handover by performing at least one of precoding matrix determination, UL frequency-selective scheduling or power control based on the estimated UL channel information.

In the meantime, an SRS signal used by the second BS 20 for UL channel estimation is transmitted by taking into account time domain synchronization between the UE 30 and the first BS 10. Accordingly, due to a difference in position between the UE 30 and the first BS 10, and the UE 30 and the second BS 20, the SRS signal of the UE 30 received by the second BS 20 may be out of sync. To solve the sync problem, the overhearing configuration information may include location information of the UE 30. The second BS 20 may estimate a channel more accurately by synchronizing the SRS signal of the UE 30 received by the second BS 20 based on the location information of the UE 30. In an embodiment of the disclosure, the overhearing configuration information may include time offset information that takes into account the position between the second BS 20 and the UE 30. The first BS 10 may provide a time offset value to be considered for decoding the SRS signal received by the second BS 20 from the UE 30 by taking into account locations of the UE 30 and the second BS 20. It is, however, merely an example, and the location information of the UE 30 or the time offset information may be provided separately from the overhearing configuration information.

In operation S470, the first BS 10 may transmit a handover command to the UE 30. For example, the first BS 10 may trigger handover by transmitting an RRC reconfiguration message to the UE 30. The handover command may include information used to access the second BS 20, which is received as a response to the handover request.

In operation S480, the UE 30 may perform handover from the first BS 10 to the second BS 20. A procedure for performing the handover may include the UE 30 transmitting a random access preamble to the second BS 20 and getting in sync, and the second BS 20, upon reception of the random access preamble, transmitting a message including UL radio resource and time alignment (TA) information in a random access response.

In operation S490, the UE 30 completes handover from the first BS 10 to the second BS 20. According to the handover, a serving BS for the UE 30 may be changed from the first BS 10 to the second BS 20. The UE 30 may transmit an RRC reconfiguration complete message to the second BS 20 after being successfully connected to the second BS 20. The second BS 20 configured to perform periodic SRS overhearing for the UE 30 may not perform the SRS overhearing operation for the UE 30 after receiving the RRC reconfiguration complete message. It is, however, merely an example, and the second BS 20 configured to perform periodic SRS overhearing for the UE 30 may not perform the SRS overhearing operation from when the handover is started.

The SRS-based overhearing operation according to the disclosure may be applied to Rach-less handover. This will be described in more detail with reference to FIG. 5.

FIG. 5 illustrates a flow chart illustrating application of SRS-based fast link adaptation to RACH-less handover, according to an embodiment of the disclosure. Operations overlapping with those shown in FIG. 4 will not be described in detail for brevity.

Referring to FIG. 5, with the RACH-less handover, the UE 30 may be connected to the second BS 20 without random access because UE 30 knows a TA value unlike with legacy handover.

In operation S510, the first BS 10 may transmit a first RRC reconfiguration message to the UE 30. The first RRC reconfiguration message may include information for SRS configuration. The UE 30 may transmit an SRS to the first BS 10 based on the information for SRS configuration (as described above in connection with FIG. 2).

In operation S520, the first BS 10 may transmit a second RRC reconfiguration message to the UE 30. In an embodiment of the disclosure, the second RRC reconfiguration message may include MR configuration information for an event related to the RACH-less handover.

In operation S530, the UE 30 may transmit an MR corresponding to the second RRC message to the first BS 10. In an embodiment of the disclosure, after detecting the event regarding the RACH-less handover, the UE 30 may transmit an MR corresponding to an event used in the MR configuration information to the first BS 10. In an embodiment of the disclosure, the MR corresponding to the event may include signal strength and quality of the first BS 10 and the second BS 20.

In operation S540, the first BS 10 may transmit a handover request to the second BS 20. On receiving the MR corresponding to the detected event, the first BS 10 may transmit the handover request to a target for handover, which is the second BS 20.

In an embodiment of the disclosure, the handover request message may include a transparent RRC container including handover preparation information along with an ID of the second BS 20 and other information.

In an embodiment of the disclosure, the handover request may include a request for SRS overhearing. The request for SRS overhearing may include information indicating activation of SRS overhearing and information for configuring SRS overhearing. In an embodiment of the disclosure, the overhearing request may be included in the transparent RRC container accompanied by the handover request, or vendor-specifically delivered. For example, the request for SRS overhearing may be configured by “RRC: srs-Config setup” IE in the RRC message. An example of information included in the “RRC: srs-Config setup” IE is as shown in Table 5. “RRC: srs-Config: setup” IE may include srs-ResourcesetId that represents resource IDs, srs-ResouceList that represents a list of resources included in the resource IDs, and resouceType that represents a signal type for each SRS resource. For example, when srs-ResourcesetId is 1, the resource list may include 1, 2, 3 and 4, and the resource signal type may include periodic SRS.

TABLE 5
RRC: srs-Config setup IE

| | |
|---|---|
| srs-Config setup: | |
| srs-ResourceSetToAddModList | srs-ResourceSetToAddModList |
| srs-ResourceSetId 0, | srs-ResourceSetId 0, |
| srs-ResourceIdList | nrofSRS-Ports port1, |
| 0 | transmissionComb n2: |
| , | combOffset-n2 0, |
| resourceType aperiodic: | cyclicShift-n2 0 |
| aperiodicSRS-ResourceTrigger | , |
| 1 | resourceMapping |
| , | startPositon 0, |
| . | nrofSymbols n1, |
| . | |
| . , | |
| srs-ResouceSetId 1, | repetitionFactor n1 |
| srs-ResourceIdList | , |
| 1, | freqDomainPosition 0, |
| 2, | freqDomainShift 0, |
| 3, | freqHoppin |
| 4 | c-SRS 0, |
| , | b-SRS 3, |
| resourceType periodic: | b-hop 3 |
| , | , |
| . | groupOrSequenceHoppin neither, |
| . | |
| . | |
| | resouceType aperiod: |
| | , |
| | sequenceId 427 |

In operation S550, the second BS 20 may transmit a response to the handover request to the first BS 10. The second BS 20 may receive the handover request and transmit ACK or NACK for the handover request.

In operation S560, the second BS 20 may perform overhearing on an SRS transmitted by the UE 30 to the first BS 10. When the second BS 20 transmits ACK, the second BS 20 may measure a signal received in an SRS resource identified based on the overhearing configuration information. Furthermore, the overhearing configuration information may include e.g., information about a cyclic shift value used for SRS generation, and based on this, the second BS 20 may identify the SRS. It is, however, merely an example, and the overhearing configuration information may include one or more pieces of information included in the SRS configuration information as described above in connection with FIG. 2.

The second BS 20 may estimate a channel between the second BS 20 and the UE 30 through signal measurement. For example, the second BS 20 may estimate a UL channel by measuring SINR, RSSI, and a path loss of the received signal. In an embodiment of the disclosure, the second BS 20 may estimate a DL channel based on the UL channel estimated through the SRS overhearing.

In operation S570, the first BS 10 may transmit a handover command to the UE 30. The first BS 10 may trigger handover by transmitting an RRC reconfiguration message to the UE 30.

The second BS 20 may determine the number of MCS levels and layers suitable for the channel state of the UE before start or completion of a handover procedure with the UE 30, based on the estimated UL channel information. Furthermore, the second BS 20 may minimize performance degradation from handover by performing precoding matrix determination, UL frequency-selective scheduling and power control based on the estimated UL channel information.

In operation S580, the second BS 20 may transmit UL grant and TA information to the UE 30.

In operation S590, the UE 30 completes handover from the first BS 10 to the second BS 20. With the handover, the UE 30 becomes a UE served by the second BS 20. In an embodiment of the disclosure, the UE 30 may transmit an RRC reconfiguration complete message to the second BS 20 after being successfully connected to the second BS 20.

FIG. 6 illustrates a flow chart illustrating application of SRS-based fast link adaptation to conditional handover, according to an embodiment of the disclosure; Operations overlapping with those shown in FIG. 4 will not be described in detail for brevity.

Referring to FIG. 6, for conditional handover, the UE 30 may determine whether to hand over. Before going into a state that may use handover, the UE 30 may receive a message used for handover from at least one second BS (BS-2a and BS-2b) 20a and 20b. For the second BS 20b that satisfies a condition for the conditional handover, the UE 30 may complete the handover without additional indication from the first BS 10.

In operation S610, the first BS 10 may transmit a first RRC reconfiguration message to the UE 30. The first RRC reconfiguration message may include configuration information for SRS. In an embodiment of the disclosure, the UE 30 may transmit an SRS to the first BS 10 as a response to the configuration information for SRS.

In operation S615, the first BS 10 may transmit a second RRC reconfiguration message to the UE 30. In an embodiment of the disclosure, the second RRC reconfiguration message may include MR configuration information for an event regarding the conditional handover.

In operation S620, the UE 30 may transmit an MR corresponding to the second RRC message to the first BS 10. In an embodiment of the disclosure, after detecting the event regarding the conditional handover, the UE 30 may transmit an MR corresponding to an event used in the MR configuration information to the first BS 10. In an embodiment of the disclosure, the MR corresponding to the event may include signal strength and quality of the first BS 10 and the at least one second BS 20a and 20b.

In an embodiment of the disclosure, an MR for conditional handover may include information about the at least one second BS 20a and 20b, which are candidates for conditional handover.

In operation S625, the first BS 10 may transmit a handover request to BS-2a 20a. In an embodiment of the disclosure, the handover request message may include a transparent RRC container including a handover preparation information RRC message along with an ID of the second BS 20 and other information.

In an embodiment of the disclosure, the handover request may include a request for SRS overhearing. The request for SRS overhearing may include information indicating activation of SRS overhearing and information for configuring SRS overhearing. In an embodiment of the disclosure, the overhearing request may be included in the transparent RRC container accompanied by the handover request, or vendor-specifically delivered. For example, the request for SRS overhearing may be configured by “RRC: srs-Config setup” IE in the RRC message. In an embodiment of the disclosure, the request for SRS overhearing may determine whether to perform overhearing for each SRS resource.

In operation S630, BS-2a 20a may transmit a response to the handover request to the first BS 10. BS-2a 20a may receive the handover request and transmit ACK or NACK for the handover request.

In operation S635, BS-2a 20a is able to perform overhearing for an SRS transmitted by the UE 30 to the first BS 10. When BS-2a 20a transmits ACK, BS-2a 20a may measure a signal received in an SRS resource identified based on the overhearing configuration information. Furthermore, the overhearing configuration information may include e.g., information about a cyclic shift value used for SRS generation, and based on the information, the second BS 20 may identify the SRS. It is, however, merely an example, and the overhearing configuration information may include one or more pieces of information included in the SRS configuration information as described above in connection with FIG. 2.

BS-2a 20a may estimate a channel between BS-2a 20a and the UE 30 through signal measurement. For example, BS-2a 20a may estimate a UL channel by measuring SINR, RSSI, and a path loss of the received signal. In an embodiment of the disclosure, BS-2a 20a may estimate a DL channel based on the UL channel estimated through the SRS overhearing.

In operation S640, the first BS 10 may transmit a handover request to BS-2b 20b. In an embodiment of the disclosure, the handover request message may include a transparent RRC container including a handover preparation information RRC message along with an ID of the second BS 20 and other information.

In an embodiment of the disclosure, the handover request may include a request for SRS overhearing. The request for SRS overhearing may include information indicating activation of SRS overhearing and information for configuring SRS overhearing. In an embodiment of the disclosure, the overhearing request may be included in the transparent RRC container accompanied by the handover request, or vendor-specifically delivered. For example, the request for SRS overhearing may be configured by “RRC: srs-Config setup” IE in the RRC message. In an embodiment of the disclosure, the request for SRS overhearing may determine whether to perform overhearing for each SRS resource.

In operation S645, BS-2b 20b may transmit a response to the handover request to the first BS 10. BS-2a 20a may receive the handover request and transmit ACK or NACK for the handover request.

In operation S650, BS-2b 20b is able to perform overhearing on an SRS transmitted by the UE 30 to the first BS 10. When BS-2b 20b transmits ACK, BS-2b 20b may measure a signal received in an SRS resource identified based on the overhearing configuration information. Furthermore, the overhearing configuration information may include e.g., information about a cyclic shift value used for SRS generation, and based on this, the second BS 20 may identify the SRS. It is, however, merely an example, and the overhearing configuration information may include one or more pieces of information included in the SRS configuration information as described above in connection with FIG. 2.

BS-2b 20b may estimate a channel between BS-2b 20b and the UE 30 through signal measurement. For example, BS-2b 20b may estimate a UL channel by measuring SINR, RSSI, and a path loss of the received signal. In an embodiment of the disclosure, BS-2b 20b may estimate a DL channel based on the UL channel estimated through the SRS overhearing.

In operation S655, the first BS 10 may transmit a third RRC reconfiguration message to the UE 30. The third RRC reconfiguration message includes configuration information for conditional handover. In an embodiment of the disclosure, the configuration information for conditional handover may include an RRC measurement configuration to help find the most suitable one of the at least one second BS 20a and 20b available for handover.

BS-2a 20a may determine the number of MCS levels and layers suitable for the channel state of the UE before start or completion of a handover procedure with the UE 30, based on the estimated UL channel information. Furthermore, BS-2a 20a may minimize performance degradation from handover by performing precoding matrix determination, UL frequency-selective scheduling and power control based on the estimated UL channel information.

In operation S660, the UE 30 may transmit, to the first BS 10, a message indicating that RRC configuration is completed.

In operation S665, the UE 30 may determine and perform conditional handover. In an embodiment of the disclosure, the UE 30 may determine whether a condition is met according to the third RRC reconfiguration message, and determine one of the at least one second BS 20a and 20b, which is the most suitable for the condition. The UE 30 may perform handover to BS-2b 20b based on the determination of conditional handover.

In operation S670, the UE 30 completes handover from the first BS 10 to the second BS 20. With the handover, the UE 30 becomes a UE served by the second BS 20. In an embodiment of the disclosure, the UE 30 may transmit an RRC reconfiguration complete message to the second BS 20 after being successfully connected to the second BS 20.

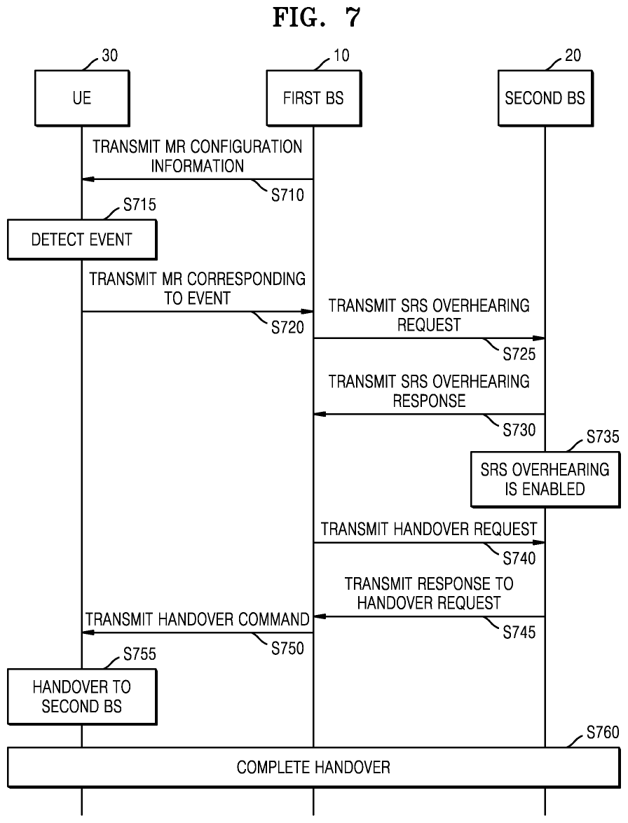

FIG. 7 illustrates a flow chart for describing transmission of an extra message for SRS overhearing in SRS-based fast link adaptation, according to an embodiment of the disclosure; Operations overlapping with those shown in FIG. 4 will not be described in detail for brevity.

In operation S710, the first BS 10 may transmit MR configuration information to the UE 30. When detecting an event based on the MR configuration information in S715, the UE 30 transmits an MR corresponding to the event to the first BS 10 in S720. In an embodiment of the disclosure, the event may include an event regarding handover, an event regarding SRS overhearing, or an event regarding multiple TRP configuration.

In operation S725, the first BS 10 may transmit an SRS overhearing request to the second BS 20. In an embodiment of the disclosure, the request for SRS overhearing may include information indicating activation of SRS overhearing and information for configuring SRS overhearing. For example, the request for SRS overhearing may be configured by “RRC: srs-Config setup” IE in the RRC message. In an embodiment of the disclosure, the first BS 10 may indicate whether overhearing is used for each SRS resource. Information about the resource and the resource ID used for SRS overhearing may be sent in the transparent container accompanied by the overhearing request, an extra container or a field.

In operation S730, the second BS 20 may transmit an SRS overhearing response to the first BS 10. The second BS 20 may transmit ACK or NACK as a response to the SRS overhearing request.

In an embodiment of the disclosure, when SRS resource information for overhearing and SRS resource information of the UE served by the second BS 20 conflicts with each other or when the second BS 20 has no room for PHY processing capability, the second BS 20 may transmit NACK for the SRS overhearing request.

In an embodiment of the disclosure, the second BS 20 may respond to the overhearing request for each SRS resource ID. The response to the overhearing request may be represented by using a bitmap corresponding to the SRS resource ID. In an embodiment of the disclosure, the second BS 20 may not respond for a resource for which the SRS overhearing request is not received. In an embodiment of the disclosure, when NACK is to be transmitted for each SRS resource ID, the second BS 20 may add information about a resource that allows SRS overhearing to the NACK and transmit the NACK. When the first BS 20 is able to configure the UE with a resource that allows SRS overhearing by the second BS 20, the first BS 10 may transmit, to the UE, an RRC message requesting a change in SRS configuration. After transmitting the RRC message, the first BS 10 may transmit, to the second BS 20, an overhearing request based on the changed SRS configuration.

In operation S735, the second BS 20 may perform overhearing on an SRS transmitted by the UE 30 to the first BS 10. When the second BS 20 transmits ACK, the second BS 20 may measure a signal received in an SRS resource identified based on the overhearing configuration information. Furthermore, the overhearing configuration information may include e.g., information about a cyclic shift value used for SRS generation, and based on the information, the second BS 20 may identify the SRS. It is, however, merely an example, and the overhearing configuration information may include one or more pieces of information included in the SRS configuration information as described above in connection with FIG. 2.

The second BS 20 may estimate a channel between the second BS 20 and the UE 30 through signal measurement. For example, the second BS 20 may estimate a UL channel by measuring SINR, RSSI, and a path loss of the received signal. In an embodiment of the disclosure, the second BS 20 may estimate a DL channel based on the UL channel estimated through the SRS overhearing.

The second BS 20 may determine the number of MCS levels and layers suitable for the channel state of the UE before start or completion of a handover procedure with the UE 30, based on the estimated UL channel information. Furthermore, the second BS 20 may minimize performance degradation from handover by performing precoding matrix determination, UL frequency-selective scheduling and power control based on the estimated UL channel information.

In an embodiment of the disclosure, the second BS 20 may collect UL channel state information (CSI) by overhearing the SRS. In an embodiment of the disclosure, the second BS 20 may transmit, to the first BS 10, a message indicating completion of collecting UL CSI.

In operation S740, the first BS 10 may transmit a handover request to the second BS 20. In an embodiment of the disclosure, the handover request may be configured with RRC: srs-Config setup IE. In an embodiment of the disclosure, the handover request message may include a transparent RRC container including a handover preparation information RRC message along with an ID of the second BS 20 and other information.

In an embodiment of the disclosure, the handover request may include resource information for handover. The resource information for handover may include other information depending on the type of handover. For example, handover may include RACH-less handover, conditional handover (CHO), dual active protocol stack (DAPS) handover, or the like.

In operation S745, the second BS 20 may transmit a response to the handover request to the first BS 10. The second BS 20 may receive the handover request and transmit ACK or NACK for the handover request.

In an embodiment of the disclosure, the response to the handover request may include a message indicating completion of collecting UL CSI through SRS overhearing.

In operation S750, the first BS 10 may transmit a handover command to the UE 30. The first BS 10 may trigger handover by transmitting an RRC reconfiguration message to the UE 30.

In an embodiment of the disclosure, the handover command may include information used to access the second BS 20, which is received as a response to the handover request.

In operation S755, the UE 30 may perform handover from the first BS 10 to the second BS 20. A procedure for performing the handover may include the UE 30 transmitting a random access preamble to the second BS 20 and getting in sync, and the second BS 20, upon reception of the random access preamble, transmitting a message including UL radio resource and TA information in a random access response.

In operation S760, the UE 30 completes handover from the first BS 10 to the second BS 20. With the handover, the UE 30 becomes a UE served by the second BS 20. In an embodiment of the disclosure, the UE 30 may transmit an RRC reconfiguration complete message to the second BS 20 after being successfully connected to the second BS 20.

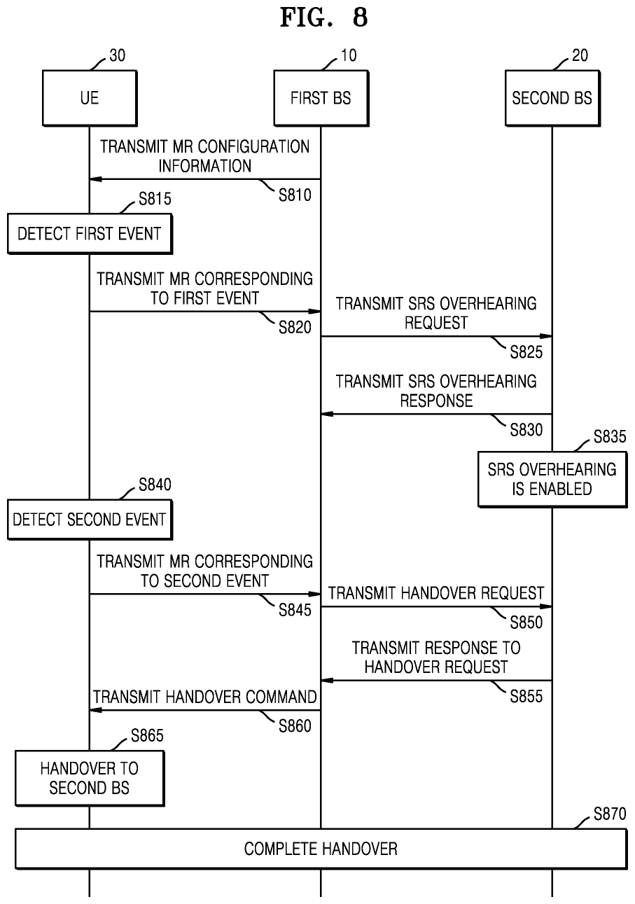

FIG. 8 illustrates a flow chart for describing presence of multiple events in SRS-based fast link adaptation, according to an embodiment of the disclosure. In an embodiment of the disclosure, events may include a first event regarding overhearing and a second event regarding handover. Operations overlapping with those shown in FIG. 7 will not be described in detail for brevity.

In operation S810, the first BS 10 may transmit at least a piece of MR configuration information to the UE 30. In an embodiment of the disclosure, the at least one piece of MR configuration information may include MR configuration information for the first event regarding overhearing and MR configuration information for the second event regarding handover.

In operation S815, the UE 30 may detect the first event regarding overhearing. In an embodiment of the disclosure, the first event regarding overhearing may have a smaller offset value than that of the second event regarding handover.

In operation S820, the UE 30 may transmit an MR corresponding to the first event to the first BS 10. Upon detection of the first event, the UE 30 transmits an MR corresponding to the event used in the MR configuration information.

In an embodiment of the disclosure, the MR corresponding to the event may include information about signal strength and quality of the first BS 10 and the second BS 20. For example, the MR may include information about RSRP, RSRQ, SINR, and PCI.

In operation S825, the first BS 10 may transmit an SRS overhearing request to the second BS 20. In an embodiment of the disclosure, the request for SRS overhearing may include information indicating activation of SRS overhearing and information for configuring SRS overhearing. For example, the request for SRS overhearing may be configured by “RRC: srs-Config setup” IE in the RRC message. In an embodiment of the disclosure, the first BS 10 may indicate whether overhearing is used for each SRS resource. In an embodiment of the disclosure, information about the resource and the resource ID used for SRS overhearing may be sent in the transparent container accompanied by the overhearing request, an extra container or a field.

In operation S830, the second BS 20 may transmit an SRS overhearing response to the first BS 10. The second BS 20 may transmit ACK or NACK as a response to the SRS overhearing request.

In operation S835, the second BS 20 may perform overhearing on an SRS transmitted by the UE 30 to the first BS 10. When the second BS 20 transmits ACK, the second BS 20 may measure a signal received in an SRS resource identified based on the overhearing configuration information. Furthermore, the overhearing configuration information may include e.g., information about a cyclic shift value used for SRS generation, and based on the information, the second BS 20 may identify the SRS. It is, however, merely an example, and the overhearing configuration information may include one or more pieces of information included in the SRS configuration information as described above in connection with FIG. 2.

The second BS 20 may estimate a channel between the second BS 20 and the UE 30 through signal measurement. For example, the second BS 20 may estimate a UL channel by measuring SINR, RSSI, and a path loss of the received signal. In an embodiment of the disclosure, the second BS 20 may estimate a DL channel based on the UL channel estimated through the SRS overhearing.

The second BS 20 may determine the number of MCS levels and layers suitable for the channel state of the UE before start or completion of a handover procedure with the UE 30, based on the estimated UL channel information. Furthermore, the second BS 20 may minimize performance degradation from handover by performing precoding matrix determination, UL frequency-selective scheduling and power control based on the estimated UL channel information.

In operation S840, the UE 30 may detect the second event regarding handover.

In operation S845, the UE 30 transmits an MR corresponding to the second event to the first BS 10. Upon detection of the second event, the UE 30 transmits an MR corresponding to the event used in the MR configuration information.

In operation S850, the first BS 10 may transmit a handover request to the second BS 20. In an embodiment of the disclosure, the handover request may be configured with RRC: srs-Config setup IE. In an embodiment of the disclosure, the handover request message may include a transparent RRC container including a handover preparation information RRC message along with an ID of the second BS 20 and other information.

In operation S855, the second BS 20 may transmit a response to the handover request to the first BS 10. The second BS 20 may receive the handover request and transmit ACK or NACK for the handover request.

In operation S860, the first BS 10 may transmit a handover command to the UE 30. The first BS 10 may trigger handover by transmitting an RRC reconfiguration message to the UE 30.

In operation S865, the UE 30 may perform handover from the first BS 10 to the second BS 20. A procedure for performing the handover may include the UE 30 transmitting a random access preamble to the second BS 20 and getting in sync, and the second BS 20, upon reception of the random access preamble, transmitting a message including UL radio resource and TA information in a random access response.

In operation S870, the UE 30 completes handover from the first BS 10 to the second BS 20. With the handover, the UE 30 becomes a UE served by the second BS 20. In an embodiment of the disclosure, the UE 30 may transmit an RRC reconfiguration complete message to the second BS 20 after being successfully connected to the second BS 20.

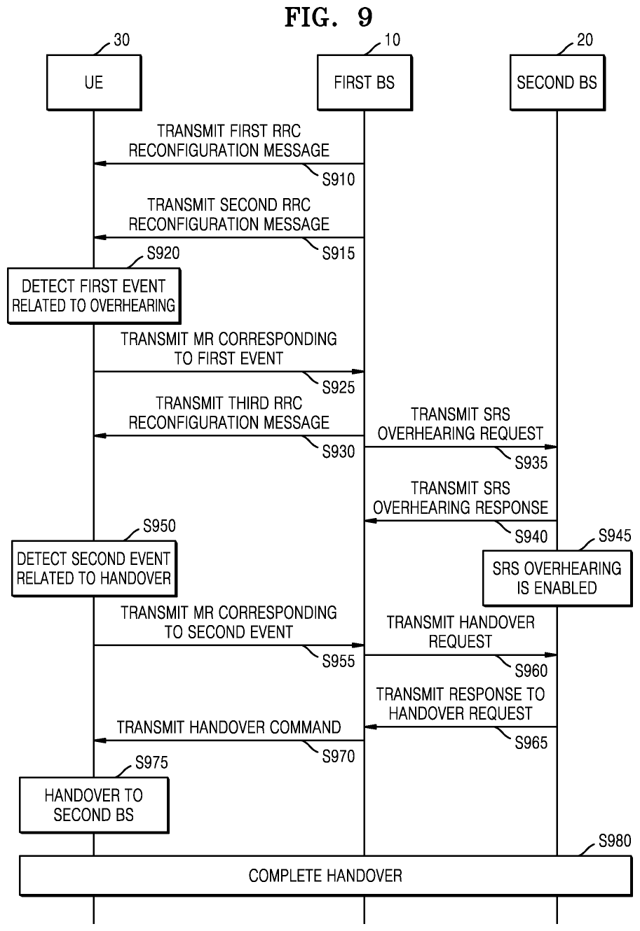

FIG. 9 illustrates a flow chart for describing additional transmission of an SRS configuration message in SRS-based fast link adaptation, according to an embodiment of the disclosure. It is similar to those of FIGS. 6 and 8 except for operation 930, which will now be described.

In operation S930, the first BS 10 may transmit a third RRC reconfiguration message to the UE 30. In an embodiment of the disclosure, the third RRC reconfiguration message may include SRS configuration information.

In an embodiment of the disclosure, the third RRC reconfiguration message may be transmitted in operation S930 on an occasion when the first RRC reconfiguration message is not transmitted in operation S910. In an embodiment of the disclosure, the occasion when the first RRC reconfiguration message is not transmitted may include an occasion when there is no need to configure an SRS in advance and an occasion when precoding matrix indication (PMI) based beamforming is used.

In an embodiment of the disclosure, the third RRC reconfiguration message may be transmitted when the SRS configured with the first RRC reconfiguration message has a long period. In an embodiment of the disclosure, when the SRS has a long period, the second BS may not collect sufficient UL CSI used with the SRS signal between operation S940 and operation S980. In an embodiment of the disclosure, the third RRC reconfiguration message may adjust the transfer period of the SRS to be short so as to collect sufficient UL CSI.

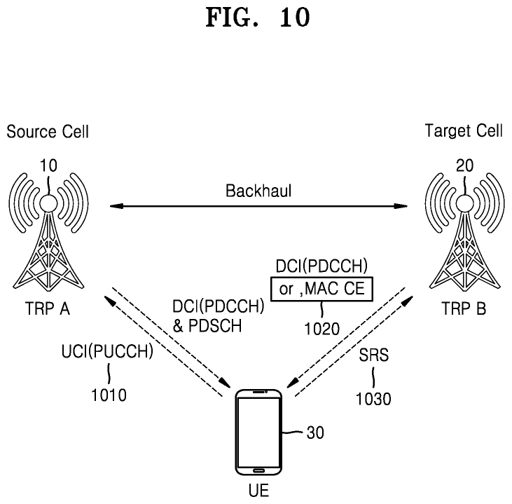

FIG. 10 illustrates a diagram for describing multiple TRPs to which SRS-based overhearing is applied, according to an embodiment of the disclosure. In some embodiments of the disclosure for describing an operation related to configuration of multiple TRPs, the first BS and the second BS 20 are referred to as TRP A and TRP B, respectively.

Referring to FIG. 10, a plurality of TRPs may be configured for the UE 30 to receive data from both BSs 10 and 20. The TRP A 10 and the TRP B 20 may have the same PCI or different PCIs. In an embodiment of the disclosure, when the plurality of TRPs are configured, not only the first BS 10 but also the second BS 20 may transmit an SRS transmission command to the UE 30. In an embodiment of the disclosure, when handover is expected, the second BS 20, instead of the first BS 10, may transmit an SRS transmission request directly to the UE 30. The UE 30 may transmit an SRS to the second BS 20 in response to the SRS transmission request. The second BS 20 may receive the SRS and estimate a channel between the UE 30 and the second BS 20. Using the estimated channel, the second BS 20 may perform a fast link adaptation method right after the handover.

In an embodiment of the disclosure, in case that the plurality of TRPs are configured, the UE 30 traditionally performs UL communication with the TRP A 10 and the TRP B 20 with uplink control information (UCI) (on physical uplink control channel (PUCCH)) and DL communication with downlink control information (DCI) (on physical downlink control channel). In the disclosure, the UE 30 may perform DL communication with the TRP B 20 with DCI (on PDCCH), MAC CE or RRC through fast link adaptation.

In an embodiment of the disclosure, in a case of communication between the UE 30 and the TRP B 20 with MAC CE, the UE 30 may transmit a semi-persistent SRS, and in a case of the communication with the PDCCH DCI, the UE 30 may transmit aperiodic SRS.

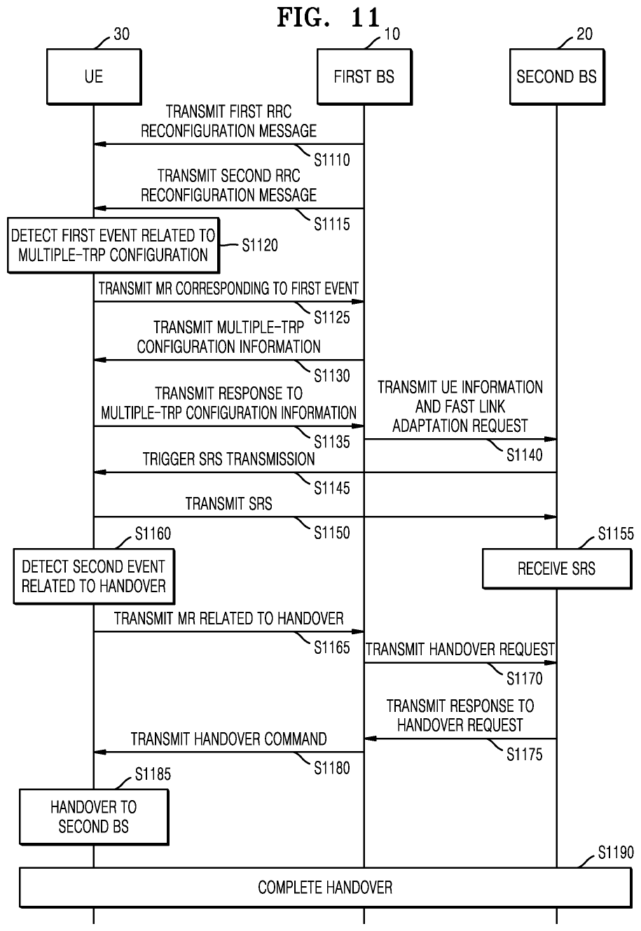

FIG. 11 illustrates a diagram illustrating application of an SRS-based fast link adaptation method to a base station (BS) configured with multiple TRPs, according to an embodiment of the disclosure. Operations overlapping with those shown in FIG. 8 will not be described in detail for brevity.

In operation S1110, the first BS 10 may transmit a first RRC reconfiguration message to the UE 30. The first RRC reconfiguration message may include SRS configuration information.

In operation S1115, the first BS 10 may transmit a second RRC reconfiguration message to the UE 30. In an embodiment of the disclosure, the second RRC reconfiguration message may include at least one piece of MR configuration information. In an embodiment of the disclosure, the at least one piece of MR configuration information may include MR configuration information for a first event regarding multiple TRP configuration and MR configuration information regarding the second event regarding handover.

In an embodiment of the disclosure, the MR configuration information for the first event regarding multiple TRP configuration may include information for determining whether to register the second BS 20 in the multiple TRPs before handover.

In operation S1120, the UE 30 may detect the first event regarding multiple TRP configuration. In an embodiment of the disclosure, the first event regarding multiple TRP configuration may have a smaller offset value than that of the second event regarding handover.

In operation S1125, the UE 30 may transmit an MR corresponding to the first event to the first BS 10. Upon detection of the first event, the UE 30 transmits an MR corresponding to the event used in the MR configuration information.

In an embodiment of the disclosure, the MR corresponding to the event may include information about signal strength and quality of the first BS 10 and the second BS 20. For example, the MR may include information about RSRP, RSRQ, SINR, and PCI.

In operation S1130, the first BS 10 may transmit multiple-TRP configuration information to the UE 30. In an embodiment of the disclosure, the information for configuring multiple TRPs may include information about the TRP B 20.

In operation S1135, the UE 30 may transmit, to the first BS 10a, a response upon reception of the multiple-TRP configuration information. In an embodiment of the disclosure, the response for the multiple TRP configuration information may include a response about whether to add the TRP B 20 to multiple TRPs for the UE 30 before handover.

In operation S1140, the first BS 10 may transmit UE information and fast link adaptation request to the second BS 20. In an embodiment of the disclosure, the request message may include a message indicating that multiple TRPs are registered for SRS overhearing. In an embodiment of the disclosure, the request message may include a message indicating that an SRS may be received from the UE 30 for fast link adaptation right after handover.

In operation S1145, the second BS 20 may trigger SRS transmission for the UE In an embodiment of the disclosure, right after handover, the second BS 20 may receive an SRS from the UE 30 for fast link adaptation. In an embodiment of the disclosure, the second BS may transmit an SRS transmission request directly to the UE 30.

In an embodiment of the disclosure, the second BS 20 may trigger SRS transmission through MAC CE, DCI or RRC. In an embodiment of the disclosure, when the second BS 20 triggers SRS transmission through MAC CE, a semi-persistent SRS may be triggered. When the second BS 20 triggers SRS transmission through DCI, an aperiodic SRS may be triggered. When the second BS 20 triggers SRS transmission through RRC, a periodic SRS may be triggered.

In operation S1150, the UE 30 may transmit an SRS to the second BS 20. In an embodiment of the disclosure, the first BS 10 may not receive the SRS transmitted by the UE 30 to the second BS 20.

In operation S1155, the second BS 20 may receive the SRS directly from the UE 30.

In operation S1160, the UE 30 may detect the second event regarding handover.

In operation S1165, the UE 30 transmits an MR corresponding to the second event to the first BS 10. Upon detection of the second event, the UE 30 transmits an MR corresponding to the event used in the MR configuration information.

In operation S1170, the first BS 10 may transmit a handover request to the second BS 20. In an embodiment of the disclosure, the handover request may be configured with RRC: srs-Config setup IE. In an embodiment of the disclosure, the handover request message may include a transparent RRC container including a handover preparation information RRC message along with an ID of the second BS 20 and other information.

In operation S1175, the second BS 20 may transmit a response to the handover request to the first BS 10. The second BS 20 may receive the handover request and transmit ACK or NACK for the handover request.

In operation S1180, the first BS 10 may transmit a handover command to the UE 30. The first BS 10 may trigger handover by transmitting an RRC reconfiguration message to the UE 30.

In operation S1185, the UE 30 may perform handover from the first BS 10 to the second BS 20. A procedure for performing the handover may include the UE 30 transmitting a random access preamble to the second BS 20 and getting in sync, and the second BS 20, upon reception of the random access preamble, transmitting a message including UL radio resource and TA information in a random access response.

In operation S1190, the UE 30 completes handover from the first BS 10 to the second BS 20. With the handover, the UE 30 becomes a UE served by the second BS 20. In an embodiment of the disclosure, the UE 30 may transmit an RRC reconfiguration complete message to the second BS 20 after being successfully connected to the second BS 20.

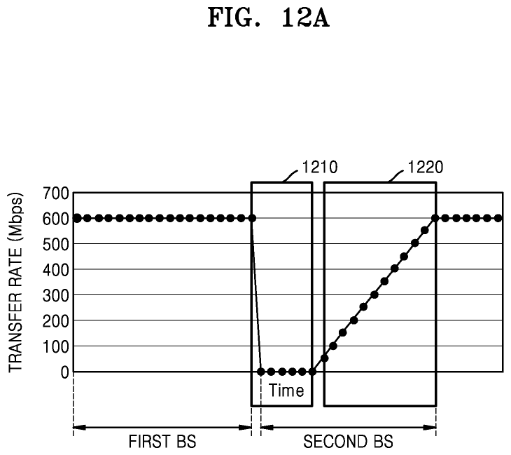

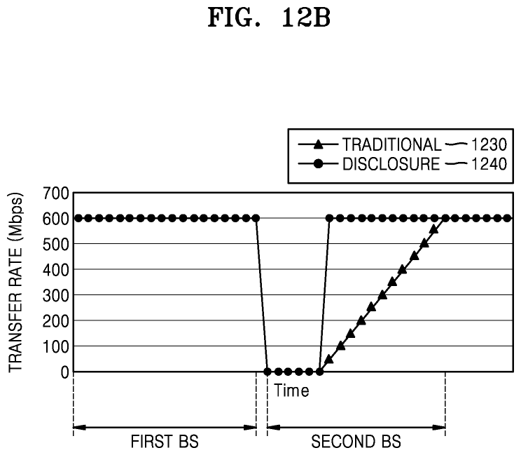

FIGS. 12A and 12B illustrate diagrams for describing change trends of transfer rate in a case of performing an SRS based fast link adaptation method, according to an embodiment of the disclosure.

FIG. 12A illustrates a graph representing transfer rates according to handover from the first BS 10 to the second BS 20. In an embodiment of the disclosure, in a state of being connected to the first BS 10, the transfer rate is 600 mega bits per second (Mbps). During a period 1210 of handover from the first BS 10 to the second BS 20, the data transfer rate drops to 0 Mbps. In an embodiment of the disclosure, right after handover, throughput degradation occurs due to a handover interruption time. In an embodiment of the disclosure, the throughput degradation 1210 may occur right after handover as the UE 30 is unable to perform data transmission or reception while performing the RACH operation. The throughput degradation 1210 due to the RACH operation may be enhanced with research to minimize the random access procedure, and for example, DAPS or 2-step RACH may be used.

In an embodiment of the disclosure, after handover is done, a throughput degradation section 1220 occurs due to robust MCS/layer allocation. In an embodiment of the disclosure, the throughput degradation section 1220 caused by the MCS/layer allocation may occur due to robust MCS/layer allocation as channel information between the UE 30 and the second BS 20 is unknown.

FIG. 12B illustrates a graph for comparing traditional trends of throughput degradation 1230 with the trends of throughput degradation according to the disclosure 1240 as the UE 30 performs handover from the first BS 10 to the second BS 20. The trends of throughput degradation from the traditional handover are the same as in FIG. 12A. In an embodiment of the disclosure, the trends of throughput degradation according to the disclosure 1240 correspond to the traditional trends of throughput degradation 1230 in the throughput degradation section 1210 caused by the RACH operation. In a throughput degradation section 1220 caused by allocation of the number of robust MCS levels and layers, the trends of the disclosure 1240 show faster restoration of transfer rate than the traditional trends 1230.

In an embodiment of the disclosure, the trends of the disclosure 1240 show that a UL channel may be estimated and UL adaptation is possible as the second BS 20 performs overhearing on the SRS transmitted by the UE 30 to the first BS 10. For example, UL channel estimation may be performed by measuring SINR, RSSI and a path loss of the uplink.

In an embodiment of the disclosure, the trends of the disclosure 1240 show that a DL channel may be estimated with the UL channel because of time division duplex (TDD) reciprocity. DL adaptation is possible on the estimated DL channel. For example, the DL channel estimation may be performed by obtaining a rank of DL, a channel matrix, and an estimated DL SINR. In an embodiment of the disclosure, for the rank of DL, the rank value may be tracked back by the BS recognizing channel information from each antenna in a case of SRS transmission based on transmit antenna selection (TAS).

As the UL channel and the DL channel between the UE 30 and the second BS 20 are estimated, the second BS 20 may perform fast link adaptation by allocating a suitable number of MCS levels and layers.

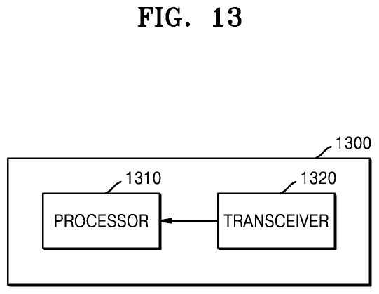

FIG. 13 illustrates a block diagram schematically illustrating a configuration of a UE, according to an embodiment of the disclosure.

Referring to FIG. 13, a UE 1300 may include a processor 1310, a transceiver 1320, and a memory (not shown). Elements of the UE 1300 are not, however, limited thereto. For example, the UE 1300 may include more or fewer elements than described above. In an embodiment of the disclosure, the processor 1310, the memory, and the transceiver 1320 may be implemented in a single chip.

The processor 1310 may include one or more processors. The one or more processors may be central processing units (CPUs), application processors (APs), digital signal processors (DSPs), etc.

The processor 1310 may control a series of processes for the UE 1300 to be operated according to the aforementioned embodiments of the disclosure. For example, the processor 1310 may receive control signals and data signals through the transceiver 1320 and process the received control signals and data signals. The processor 1310 may transmit the processed control signal and data signal through the transceiver 1320, and detect an event. Furthermore, the processor 1310 may control input data derived from the received control signal and data signal to be processed according to a predefined operation rule or artificial intelligence (AI) model stored in the memory. The processor 1310 may record data to the memory or read out data from the memory. The processor 1310 may further perform functions of a protocol stack requested by a communication standard. In an embodiment of the disclosure, the processor 1310 may include at least one processor. In an embodiment of the disclosure, part of the transceiver 1320 or the processor 1310 may be referred to as a communication processor (CP).

The memory may store a program and data used for operation of the UE 1300. Furthermore, the memory may store control information or data included in a signal obtained by the UE 1300. Furthermore, the memory may store predefined operation rules or an AI model used by the UE 1300. The memory may include a storage medium such as a read only memory (ROM), a random access memory (RAM), a hard disk, a compact disk (CD) ROM (CD-ROM), and a digital versatile disk (DVD), or a combination of storage mediums. Alternatively, the memory may not be separately present but integrated into the processor 1310. The memory may include a volatile memory, a non-volatile memory, or a combination of the volatile memory and the non-volatile memory. The memory may also provide the stored data at the request of the processor 1310.

The transceiver 1320 may refer to a transmitter and a receiver, and the transceiver 1320 of the UE 1300 may transmit or receive signals to or from a BS or a network entity. The signals may include control information and data. For this, the transceiver 1320 may include an RF transmitter for up-converting the frequency of a signal to be transmitted and amplifying the signal and an RF receiver for low-noise amplifying a received signal and down-converting the frequency of the received signal. It is merely an example of the transceiver 1320, and the elements of the transceiver 1320 are not limited to the RF transmitter and RF receiver. In addition, the transceiver 1320 may receive a signal on a wireless channel and output the signal to the processor 1310, and transmit a signal output from the processor 1310 on a wireless channel.

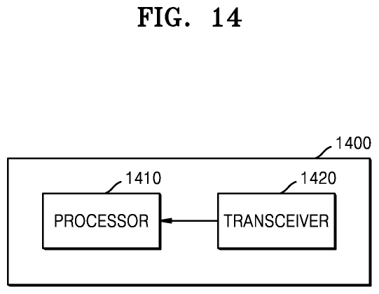

FIG. 14 illustrates a schematic block diagram illustrating a configuration of a BS, according to an embodiment of the disclosure.

Referring to FIG. 14, the BS 1400 may include a processor 1410, a transceiver 1420 and a memory (not shown). The transceiver 1420, the processor 1410 and the memory of the BS 1400 may operate according to the aforementioned communication method of the BS 1400. Elements of the BS 1400 are not, however, limited thereto. For example, the base station 1400 may include more or fewer elements than described above. In an embodiment of the disclosure, the transceiver 1420, the processor 1410, and the memory may be implemented in a single chip. The processor 1410 may include one or more processors.

The processor 1410 may control a series of processes for the BS 1400 to be operated according to the embodiments of the disclosure. For example, the processor 1410 may receive control signals and data signals through the transceiver 1420 and process the received control signals and data signals. The processor 1410 may transmit the processed control signal and data signal through the transceiver 1420. The processor 1410 may record data to the memory or read out data from the memory. The processor 1410 may perform functions of a protocol stack requested by a communication standard. For this, the processor 1410 may include at least one processor or microprocessor. In an embodiment of the disclosure, part of the transceiver 1420 and the processor 1410 may be referred to as a CP.

The processor 1410 may include one or more processors. The one or more processors may be CPUs, APs, DSPs, etc.

A receiver and a transmitter of the BS 1400 are collectively referred to as the transceiver 1420, which may transmit or receive signals to or from a UE or a network entity. The signals to be transmitted to or received from the UE or the network entity may include control information and data. For this, the transceiver 1420 may include an RF transmitter for up-converting the frequency of a signal to be transmitted and amplifying the signal and an RF receiver for low-noise amplifying a received signal and down-converting the frequency of the received signal. It is merely an example of the transceiver 1420, and the elements of the transceiver 1420 are not limited to the RF transmitter and RF receiver.

The transceiver 1420 may perform functions for transmitting and receiving signals on a wireless channel. For example, the transceiver 1420 may receive a signal on a wireless channel and output the signal to the processor 1410, and transmit a signal output from the processor 1410 on a wireless channel.

The memory may store a program and data used for operation of the BS 1400. Furthermore, the memory may store control information or data included in a signal obtained by the BS. The memory may include a storage medium such as a ROM, a RAM, a hard disk, a CD-ROM, and a DVD, or a combination of storage mediums. Alternatively, the memory may not be separately present but integrated into the processor 1410. The memory may include a volatile memory, a non-volatile memory, or a combination of the volatile memory and the non-volatile memory. The memory may also provide the stored data at the request of the processor 1410.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a storage medium (e.g., a CD-ROM), through an application store, directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

According to embodiments of the disclosure, a fast link adaptation method may be provided through SRS overhearing.

According to an embodiment of the disclosure, provided is a method of performing communication by a first base station (BS) in a wireless communication system. The method includes transmitting, to a user equipment (UE) served by the first BS, configuration information for at least one measurement report (MR), receiving, from the UE, an MR corresponding to an event when the event is detected by the UE based on the configuration information for the at least one MR, and transmitting, to at least one second BS for handover, overhearing configuration information for a sounding reference signal (SRS) transmitted from the UE to the first BS, wherein the overhearing configuration information is used to estimate a channel state based on the SRS between the at least one second BS and the UE.

According to an embodiment of the disclosure, the overhearing configuration information may include at least one of antenna port information or time-frequency resource information in which an SRS for which overhearing is requested is transmitted, and the at least one second BS having received the overhearing configuration information may receive the SRS based on at least one of the time-frequency resource information or the antenna port information.

According to an embodiment of the disclosure, the configuration information for MR may include configuration information relating to a criterion of triggering an event related to handover, and the transmitting of the overhearing configuration information may include transmitting a handover request including the overhearing configuration information to the at least one second BS when an MR corresponding to the event related to handover is received.

According to an embodiment of the disclosure, the configuration information for MR may include at least one of configuration information relating to a criterion of triggering an event related to overhearing or configuration information relating to a criterion of triggering an event related to handover, and the transmitting of the overhearing configuration information may include transmitting the overhearing configuration information to the at least one second BS when at least one of an MR corresponding to an event related to overhearing or an MR corresponding to an event related to handover is received.

According to an embodiment of the disclosure, the method may further include receiving a response to the overhearing configuration information from the at least one second BS, and transmitting a handover request for the UE to the at least one second BS.

According to an embodiment of the disclosure, the configuration information for MR may include configuration information relating to a criterion of triggering an event for configuring multiple transmission-reception points (TRPs), the method may further include transmitting configuration information for multiple TRPs to the UE when an MR corresponding to the event for configuring multiple TRPs is received from the UE, and transmitting, to the at least one second BS, a fast link adaptation request including information of the UE in which the event for configuring multiple TRPs occurs, and based on the fast link adaptation request, an SRS may be transmitted from the UE to the at least one second BS when a control signal to request SRS transmission is transmitted from the at least one second BS to the UE.

According to an embodiment of the disclosure, provided is a method of performing communication by a second BS in a wireless communication system. The method includes, in response to a first BS receiving an MR corresponding to an event from a UE served by the first BS based on the event detected by the UE based on configuration information for at least one MR, receiving overhearing configuration information for an SRS transmitted to the first BS from the UE, receiving the SRS based on the overhearing configuration information, and estimating a channel state between the UE and the second BS based on the received SRS.

According to an embodiment of the disclosure, the overhearing configuration information for the SRS may include at least one of antenna port information or time-frequency resource information in which an SRS for which overhearing is requested is transmitted, and the second BS may receive the SRS based on at least one of the time-frequency resource information or the antenna port information.

According to an embodiment of the disclosure, the configuration information for MR may include configuration information relating to a criterion of triggering an event related to handover, and the receiving of the overhearing configuration information may include receiving a handover request including the overhearing configuration information when the first BS receives an MR corresponding to the event related to handover.

According to an embodiment of the disclosure, the configuration information for MR may include at least one of configuration information relating to a criterion of triggering an event related to overhearing or configuration information relating to a criterion of triggering an event related to handover, and the receiving of the overhearing configuration information may include receiving the overhearing configuration information when the first BS receives at least one of an MR corresponding to an event related to overhearing or an MR corresponding to an event related to handover.

According to an embodiment of the disclosure, the method may further include transmitting a response to the overhearing configuration information to the first BS; and receiving a handover request for the UE from the first BS.

According to an embodiment of the disclosure, the method may further include transmitting, to the first BS, information about at least one SRS resource to be received by the second BS along with non-acknowledgment (NACK) for the overhearing configuration information, when it is not possible to receive an SRS based on the overhearing configuration information.

According to an embodiment of the disclosure, the configuration information for MR may include configuration information relating to a criterion of triggering a multiple-TRP configuration event, and method may further include receiving a fast link adaptation request including information of the UE based on an MR corresponding to the multiple-TRP configuration event received by the first BS from the UE, transmitting a control signal to request SRS transmission to the UE based on the fast link adaptation request, and receiving an SRS based on the control signal from the UE.

According to an embodiment of the disclosure, provided is a method performing communication by a UE in a wireless communication system. The method includes receiving configuration information for at least one MR from a first BS which is a serving BS, and when detecting an event based on the configuration information for the at least one MR, transmitting, to the first BS, an MR corresponding to the event, wherein overhearing configuration information is received by at least one second BS for handover from the first BS based on the received MR, wherein the at least one second BS receives an SRS transmitted from the UE to the first BS, based on the overhearing configuration information, and wherein a channel state between the UE and the at least one second BS is estimated based on the SRS.

According to an embodiment of the disclosure, provided is a first BS for performing communication in a wireless communication system. The first BS includes a transceiver, and at least one processor coupled to the transceiver, wherein the at least one processor is configured to transmit, to a UE served by the first BS, configuration information for at least one MR, receive, from the UE, an MR corresponding to an event when the event is detected by the UE based on the configuration information for the at least one MR, and transmit, to at least one second BS for handover, overhearing configuration information for a SRS transmitted from the UE to the first BS, wherein the overhearing configuration information is used to estimate a channel state based on the SRS between the at least one second BS and the UE.

According to an embodiment of the disclosure, provided is a second BS for performing communication in a wireless communication system. The second BS includes a transceiver, and at least one processor coupled to the transceiver, wherein the at least one processor is configured to, in response to a first BS receiving an MR corresponding to an event from a UE served by the first BS based on the event detected by the UE based on configuration information for at least one MR, receive overhearing configuration information for a SRS transmitted to the first BS from the UE based on the received MR, receive the SRS based on the overhearing configuration information, and estimate a channel state between the UE and the second BS based on the received SRS.

According to an embodiment of the disclosure, a UE for performing communication in a wireless communication system includes a transceiver, and at least one processor coupled to the transceiver, wherein the at least one processor is configured to receive configuration information for at least one MR from a first BS which is a serving BS, and transmit, to the first BS, an MR corresponding to an event when the event is detected by the UE based on the configuration information for the at least one MR, wherein overhearing configuration information is received by at least one second BS for handover from the first BS based on the received MR, wherein the at least one second BS receives an SRS transmitted from the UE to the first BS, based on the overhearing configuration information, and wherein a channel state between the UE and the at least one second BS is estimated based on the SRS.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of performing communication by a first base station (BS) in a wireless communication system, the method comprising:
transmitting, to a user equipment (UE) served by the first BS, configuration information for at least one measurement report (MR);
receiving, from the UE, an MR associated with an event detected by the UE based on the configuration information for the at least one MR; and
transmitting, to at least one second BS, a first message including overhearing configuration information associated with a sounding reference signal (SRS) transmitted from the UE to the first BS,
wherein the overhearing configuration information is used for overhearing the SRS by the at least one second BS.

2. The method of claim 1, wherein the overhearing configuration information comprises at least one of antenna port information or time-frequency resource information in which an SRS for which overhearing is requested is transmitted, and
wherein the at least one second BS having received the first message including the overhearing configuration information receives the SRS based on at least one of the time-frequency resource information or the antenna port information.

3. The method of claim 1, wherein the configuration information for MR comprises configuration information relating to a criterion of triggering an event related to handover, and
wherein the transmitting of the first message including the overhearing configuration information comprises transmitting a handover request message including the overhearing configuration information to the at least one second BS when an MR associated with the event related to handover is received.

4. The method of claim 1, wherein the configuration information for MR comprises at least one of configuration information relating to a criterion of triggering an event related to overhearing or configuration information relating to a criterion of triggering an event related to handover, and
wherein the transmitting of the first message including the overhearing configuration information comprises transmitting the first message including the overhearing configuration information to the at least one second BS when at least one of an MR associated with an event related to overhearing or an MR associated with an event related to handover is received.

5. The method of claim 1, further comprising:
receiving a response message to the overhearing configuration information from the at least one second BS; and
transmitting a handover request message for the UE to the at least one second BS.

6. The method of claim 1, wherein the configuration information for MR comprises configuration information relating to a criterion of triggering a multiple transmission-reception-point (TRP) configuration event, and
the method further comprises:
transmitting configuration information for multiple TRPs to the UE when an MR associated with the multiple-TRP configuration event is received from the UE; and
transmitting, to the at least one second BS, a fast link adaptation request message including information of a UE in which the multiple-TRP configuration event occurs, and
wherein, based on the fast link adaptation request message, an SRS is transmitted from the UE to the at least one second BS when a control signal to request SRS transmission is transmitted from the at least one second BS to the UE.

7. A method of performing communication by a second base station (BS) in a wireless communication system, the method comprising:
receiving, from a first BS, a first message including overhearing configuration information associated with a sounding reference signal (SRS) transmitted to the first BS from a user equipment (UE);
transmitting, to the first BS, a response message in response to receiving the first message; and
receiving the SRS based on the overhearing configuration information.

8. The method of claim 7, wherein the overhearing configuration information associated with the SRS comprises at least one of antenna port information or time-frequency resource information in which an SRS for which overhearing is requested is transmitted, and
wherein the second BS receives the SRS based on at least one of the time-frequency resource information or the antenna port information.

9. The method of claim 7, wherein the configuration information for at least one measurement report (MR) comprises configuration information relating to a criterion of triggering an event related to handover, and
wherein the receiving of the first message including the overhearing configuration information comprises receiving a handover request message including the overhearing configuration information when the first BS receives an MR associated with the event related to handover.

10. The method of claim 7, wherein the configuration information for at least one measurement report (MR) comprises at least one of configuration information relating to a criterion of triggering an event related to overhearing or configuration information relating to a criterion of triggering an event related to handover, and
wherein the receiving of the first message including the overhearing configuration information comprises receiving the first message including the overhearing configuration information when the first BS receives at least one of an MR associated with an event related to overhearing or an MR associated with an event related to handover.

11. The method of claim 7, further comprising:
receiving a handover request message for the UE from the first BS; and
transmitting a response message to the handover request message to the first BS.

12. The method of claim 7, wherein the transmitting of the response message comprises:
transmitting, to the first BS, information about at least one SRS resource to be received by the second BS along with a non-acknowledgment (NACK) for the overhearing configuration information, when it is not possible to receive an SRS based on the overhearing configuration information.

13. The method of claim 7, wherein the configuration information for at least one measurement report (MR) comprises configuration information relating to a criterion of triggering a multiple-TRP configuration event, and
the method further comprises:
receiving a fast link adaptation request message including information of the UE based on an MR associated with the multiple-TRP configuration event received by the first BS from the UE;
transmitting a control signal to request SRS transmission to the UE based on the fast link adaptation request message; and
receiving an SRS based on the control signal from the UE.

14. A method performing communication by a user equipment (UE) in a wireless communication system, the method comprising:
receiving configuration information for at least one measurement report (MR) from a first base station (BS) which is a serving BS; and
when detecting an event based on the configuration information for the at least one MR, transmitting, to the first BS, an MR associated with the event,
wherein a first message including overhearing configuration information is received by at least one second BS from the first BS based on the received MR, and
wherein the at least one second BS receives a sounding reference signal (SRS) transmitted from the UE to the first BS, based on the overhearing configuration information.

15. The method of claim 14, wherein the overhearing configuration information comprises at least one of antenna port information or time-frequency resource information in which an SRS for which overhearing is requested is transmitted, and
wherein the at least one second BS having received the first message including the overhearing configuration information receives the SRS based on at least one of the time-frequency resource information or the antenna port information.

16. The method of claim 14, wherein the configuration information for MR comprises at least one of configuration information relating to a criterion of triggering an event related to overhearing or configuration information relating to a criterion of triggering an event related to handover, and
wherein the first message including the overhearing configuration information is received by the at least one second BS when at least one of an MR associated with an event related to overhearing or an MR associated with an event related to handover is transmitted.

17. The method of claim 14, wherein the configuration information for MR comprises configuration information relating to a standard of triggering a multiple transmission-reception point (TRP) configuration event and,
the method further comprises:
receiving configuration information for multiple TRPs from the first BS when an MR associated with the multiple-TRP configuration event is transmitted;
receiving a control signal to request transmission of the SRS from the at least one second BS; and
transmitting the SRS to the at least one second BS,
wherein a fast link adaptation request including information about the UE is received by the at least one second BS from the first BS.
